(19) United States
(12) Patent Application Publication
(10) Pub. No.: US 2018/0196931 A1
(43) Pub. Date: Jul. 12, 2018

(54) ELECTRONIC DEVICE AND METHOD FOR CONTROLLING DISPLAY UNIT INCLUDING A BIOMETRIC SENSOR

(71) Applicant: Samsung Electronics Co., Ltd., Gyeonggi-do (KR)

(72) Inventors: Joungmin CHO, Seoul (KR); Namhyeon JEON, Seoul (KR); Hyunchang SHIN, Gyeonggi-do (KR); Woonbo YEO, Gyeonggi-do (KR); Taesung KIM, Gyeonggi-do (KR); Gyusang CHO, Gyeonggi-do (KR); Heungsik SHIN, Gyeonggi-do (KR); Jiwoong OH, Seoul (KR)

(21) Appl. No.: 15/862,720

(22) Filed: Jan. 5, 2018

(30) Foreign Application Priority Data
Jan. 6, 2017 (KR) 10-2017-0002422

(51) Int. Cl. G06F 21/32; G06F 3/041

(52) U.S. Cl. CPC G06F 21/32; G06K 9/0002; G06F 3/0412; G06F 3/0416

(57) ABSTRACT

The present disclosure relates to an electronic device and a method for controlling a display that includes a biometric sensor. The electronic device may include: a display including a first area having a first pixel controlled by a first signal and powered by a first power supply and a second area having a second pixel controlled by a second signal and powered by a second power supply; and a biometric sensor disposed in the first area and configured to acquire biometric information.

### CLAIM OF PRIORITY

This application claims the benefit under 35 U.S.C. § 119(a) of a Korean patent application filed on Jan. 6, 2017, in the Korean Intellectual Property Office and assigned Serial No. 10-2017-0002422, the entire disclosure of which is hereby incorporated by reference.

### TECHNICAL FIELD

Various embodiments of the present disclosure generally relate to an electronic device and a method for controlling a display that includes a biometric sensor.

### BACKGROUND

With the development of information and communication technologies, semiconductor technologies, and the like, mobile electronic devices, for example, smart phones, have become commonplace. Users may get various services by installing various applications on their smart phones.

In recent years, these electronic devices have been equipped with sensors for recognizing user's biometric information for user authentication, and the like. For example, an electronic device may include, as a biometric sensor, a fingerprint recognition module, a proximity sensor module, an illumination sensor module, an iris sensing module, or the like.

In the conventional electronic device, the biometric sensor is mainly mounted in a non-display area that does not overlap with the display of the electronic device. For example, the biometric sensor may be disposed in an area on the front surface on which the display is disposed above the display or below the display.

Thus, in the conventional electronic device, the biometric sensor may require a certain thickness in the bezels or margins around the display. But increasingly, thin bezels that maximize display area have become increasingly desirable. In the conventional electronic device, it may be difficult to reduce the margin of the non-display area due to the biometric sensor.

### SUMMARY

Accordingly, embodiments of the present disclosure are directed to an electronic device and a method for controlling a display that includes a biometric sensor capable of meeting needs of users who want to have a larger screen area. This is done by allowing a biometric sensor to be arranged within the screen area of the display.

Objects of the present disclosure are not limited to the above-mentioned objects. That is, other objects that are not mentioned above may be apparent to those skilled in the art after reading the following description.

Various embodiments of the present disclosure are directed to an electronic device including: a display including a first area having a first pixel controlled by a first signal and powered by a first power supply and a second area having a second pixel controlled by a second signal and powered by a second power supply; and a biometric sensor disposed in the first area and configured to acquire biometric information.

Various embodiments of the present disclosure are directed to an electronic device including: a display configured to include a display area and a non-display area; a biometric sensor disposed in at least a part of the display area of the display; and a processor configured to control the display and the biometric sensor, where the display area includes a first area corresponding to a location of the biometric sensor and a second area separate from the first area, and where, if a touch or hover input from a user to the first area is sensed, the processor is further configured to differently control driving states of the first and second areas, and acquire biometric information of the user using the biometric sensor.

Various embodiments of the present disclosure are directed to a method for controlling an electronic device, in which a biometric sensor is disposed in at least a part of a display area of a display and the display area includes a first area corresponding to a location of the biometric sensor and a second area separate from the first area, the control method including: if a touch or hover input from a user to the first area is sensed, differently controlling driving states of the first area and the second area; and acquiring biometric information of the user using the biometric sensor.

According to various embodiments of the present disclosure, it is possible to have larger screen area (display area) of the display by allowing the biometric sensor to be arranged to overlap the display area. In doing so, various embodiments of the present disclosure may partially control the display in the sensing state of the electronic device to prevent leakage current that interferes with the display.

The effects that may be achieved by the embodiments of the present disclosure are not limited to the above-mentioned objects. That is, other effects that are not mentioned may be apparent to those skilled in the art to which the present disclosure pertains from the following description.

### BRIEF DESCRIPTION OF THE DRAWINGS

FIG. 1 is a block diagram illustrating an electronic device according to an embodiment of the present disclosure.

FIG. 2 is a block diagram illustrating an electronic device according to an embodiment of the present disclosure.

FIG. 3 is a block diagram illustrating one or more program modules according to an embodiment of the present disclosure.

FIG. 4A and FIG. 4B are diagrams illustrating an electronic device according to an embodiment of the present disclosure.

FIG. 5 is a diagram illustrating a structure of a biometric sensor that is mounted in an area of a display of an electronic device according to an embodiment of the present disclosure.

FIG. 6 is a block diagram illustrating an electronic device according to an embodiment of the present disclosure.

FIG. 7 is a block diagram illustrating an electronic device according to another embodiment of the present disclosure.

FIG. 8 is a block diagram illustrating an electronic device according to an embodiment of the present disclosure.

FIG. 9 is a diagram illustrating a front appearance of an electronic device according to an embodiment of the present disclosure.

FIG. 10 is a diagram illustrating a front appearance of an electronic device according to another embodiment of the present disclosure.

FIG. 11 A and FIG. 11 B are diagrams illustrating a method of controlling a display while the electronic device according to an embodiment of the present disclosure senses fingerprint information.

FIG. 12 is a diagram schematically illustrating a cross section of a display in the sensing state of the electronic device, according to an embodiment of the present disclosure.

FIG. 13 is a circuit diagram illustrating a display and a display driver according to an embodiment of the present disclosure.

FIG. 14 is a circuit diagram illustrating a pixel driving circuit and an organic light emitting diode according to an embodiment of the present disclosure.

FIG. 15 is a block diagram illustrating an electrode and a power supply line for applying a driving voltage to a pixel in a display according to an embodiment of the present disclosure.

FIG. 16 is a diagram illustrating a driving voltage supplied to a display according to an embodiment of the present disclosure.

FIG. 17 is a block exemplified diagram illustrating a line for supplying a light emitting signal to each pixel of the display according to an embodiment of the present disclosure.

FIG. 18 is a diagram illustrating a light emitting signal applied to a light emitting signal supply line according to an embodiment of the present disclosure.

FIG. 19 is a block diagram illustrating a control circuit and a power supply circuit of a display according to an embodiment of the present disclosure.

FIG. 20 is a block diagram illustrating an example in which a light emitting power supply of a panel area corresponding to a fingerprint sensor is separated from a display panel, according to an embodiment of the present disclosure.

FIG. 21 A and FIG. 21 B are diagrams illustrating a method of controlling a display while the electronic device according to another embodiment of the present disclosure senses fingerprint information.

FIG. 22 is a diagram schematically illustrating a cross section of a display in a sensing state of an electronic device, according to an embodiment of the present disclosure.

FIG. 23 is a diagram illustrating the sensing state of the electronic device, according to an embodiment of the present disclosure.

FIG. 24 A and FIG. 24 B are diagrams illustrating a case in which an electronic device according to an embodiment of the present disclosure is in a sleep state.

FIG. 25 is a circuit diagram illustrating a method for partially controlling a transistor of a display panel according to an embodiment of the present disclosure.

FIG. 26 is a flow chart illustrating an operation of the electronic device according to an embodiment of the present disclosure.

FIG. 27 is a flow chart illustrating a process of partially controlling a display according to an embodiment of the present disclosure.

FIG. 28 is a flow chart illustrating a process of partially controlling a display that includes the driving of an IR LED, according to an embodiment of the present disclosure.

FIG. 29 is a flow chart of an operation of an electronic device according to an embodiment of the present disclosure.

### DETAILED DESCRIPTION

The following description with reference to the accompanying drawings is provided to assist in a comprehensive understanding of various embodiments of the present disclosure as claimed by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and structures may be omitted for clarity and conciseness.

The terms and words used in the following description and claims are not limited to the dictionary meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” may also refer to the plural, unless otherwise specified. Thus, for example, reference to “a component surface” includes reference to one or more of such surfaces.

The expressions such as “include” and “may include” may denote the presence of the disclosed functions, operations, and constituent elements and do not limit one or more additional functions, operations, and constituent elements. Terms such as “include” and/or “have” may be construed to denote a certain characteristic, operation, constituent element, component or a combination thereof, but may not be construed to exclude the existence of or a possibility of addition of one or more other characteristics, operations, constituent elements, components or combinations thereof.

Furthermore, in the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” etc., may refer to various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. A first element could be termed a second element, and similarly, a second element could be also termed a first element without departing from the scope of the present disclosure.

In the case where a component is referred to as being “connected to” or “accessed be” another component, it should be understood that the component may not be directly connected to or accessed by the other component, but also there may exist another component between them. Meanwhile, in the case where a component is referred to as being “directly connected to” or “directly accessed by” another component, it should be understood that there is no third component therebetween. The terms used in the present disclosure are only used to describe specific various embodiments, and are not intended to limit the present disclosure.

Electronic devices according to various embodiments of the present disclosure may be smartphones, tablet personal computers (PCs), mobile phones, video telephones, e-book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, wearable devices (e.g., head-mounted-devices (HMDs), such as electronic glasses), electronic apparel, electronic bracelets, electronic necklaces, electronic appcessories, electronic tattoos, smart watches, and the like.

According to another embodiment, the electronic devices may be home appliances, such as televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™or PlayStation™), electronic dictionaries, electronic keys, camcorders, electronic picture frames, or the like.

According to another embodiment, the electronic devices may be medical devices (e.g., various portable medical measurement devices, such as blood glucose monitoring devices, heartbeat measuring devices, blood pressure measuring devices, body temperature measuring devices, etc., magnetic resonance angiography (MRA) devices, magnetic resonance imaging (MRI) devices, computed tomography (CT) devices, medical scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales devices (POSs), or IoT (Internet of Things) devices (e.g., light bulbs, sensors, electric or gas meters, sprinkler devices, fire alarms, thermostats, street lamps, toasters, exercise equipment, hot water tanks, heaters, boilers, and the like). It may be readily apparent to those skilled in the art that the electronic device according to the present disclosure is not limited to the aforementioned devices.

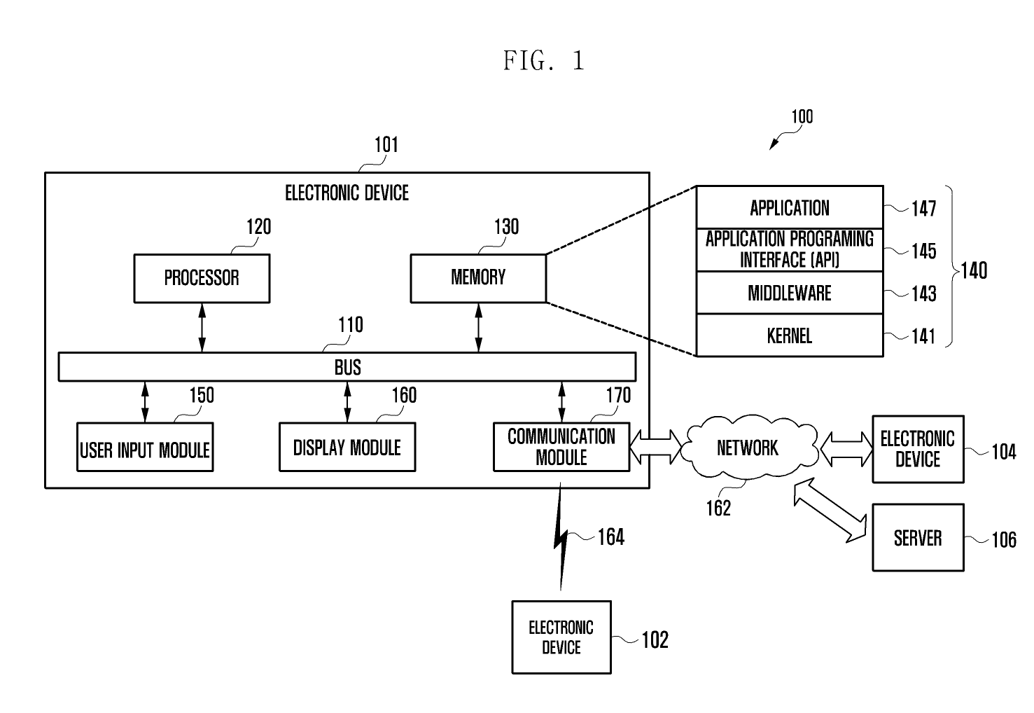

FIG. 1 is a block diagram illustrating an electronic device according to an embodiment of the present disclosure.

Referring to FIG. 1, the electronic device 101 may include a bus 110, a processor 120, a memory 130, an input/output interface 150, a display 160 and a communication interface 170, and other similar and/or suitable components.

The bus 110 may be a circuit which interconnects the above-described elements and delivers a communication (e.g., a control message) between the above-described elements. The processor 120 may receive commands from the above-described other elements (e.g., the memory 130, input/output interface 150, the display 160, the communication interface 170, etc.) through the bus 110, may interpret the received commands, and may execute calculation or data processing according to the interpreted commands. The processor 120 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for.” In addition, an artisan understands and appreciates that a “processor” or “microprocessor” may be hardware in the claimed disclosure. Under the broadest reasonable interpretation, the appended claims are statutory subject matter in compliance with 35 U.S.C. § 101.

The memory 130 may store commands or data received from the processor 120 or other elements (e.g., the input/output interface 150, a display 160 and a communication interface 170, etc.) or generated by the processor 120 or the other elements. The memory 130 may include programming modules, such as a kernel 131, middleware 132, an Application Programming Interface (API) 133, an application 134, and the like. Each of the above-described programming modules may be implemented in software, firmware, hardware, or a combination of two or more thereof.

The kernel 131 may control or manage system resources (e.g., the bus 110, the processor 120, the memory 130, and/or other hardware and software resources) used to execute operations or functions implemented by other programming modules (e.g., the middleware 132, the API 133, and the application 134). Also, the kernel 131 may provide an interface capable of accessing and controlling or managing the individual elements of the electronic device 101 by using the middleware 132, the API 133, or the application 134.

The middleware 132 may serve to go between the API 133 or the application 134 and the kernel 131 in such a manner that the API 133 or the application 134 communicates with the kernel 131 and exchanges data therewith. Also, in relation to work requests received from one or more applications 134 and/or the middleware 132, for example, may perform load balancing of the work requests by using a method of assigning a priority, in which system resources (e.g., the bus 110, the processor 120, the memory 130, etc.) of the electronic device 101 can be used, to at least one of the one or more applications 134.

The API 133 is an interface through which the application 134 is capable of controlling a function provided by the kernel 131 or the middleware 132, and may include, for example, at least one interface or function for file control, window control, image processing, character control, or the like.

The input/output interface 150, for example, may receive a command or data as input from a user, and may deliver the received command or data to the processor 120 or the memory 130 through the bus 110. The display module 160 may display a video, an image, data, or the like to the user.

The communication interface module 170 may connect communication between another electronic device 102 and the electronic device 101. The communication interface module 170 may support a predetermined short-range communication protocol (e.g., Wi-Fi, BlueTooth (BT), and Near Field Communication (NFC)), or predetermined network 162 (e.g., the Internet, a Local Area Network (LAN), a Wide Area Network (WAN), a telecommunication network, a cellular network, a satellite network, a Plain Old Telephone Service (POTS), or the like). Each of the electronic devices 102 and 104 may be a device which is identical (e.g., of an identical type) to or different (e.g., of a different type) from the electronic device 101. Further, the communication interface module 170 may connect communication between a server 164 and the electronic device 101 via the network 162.

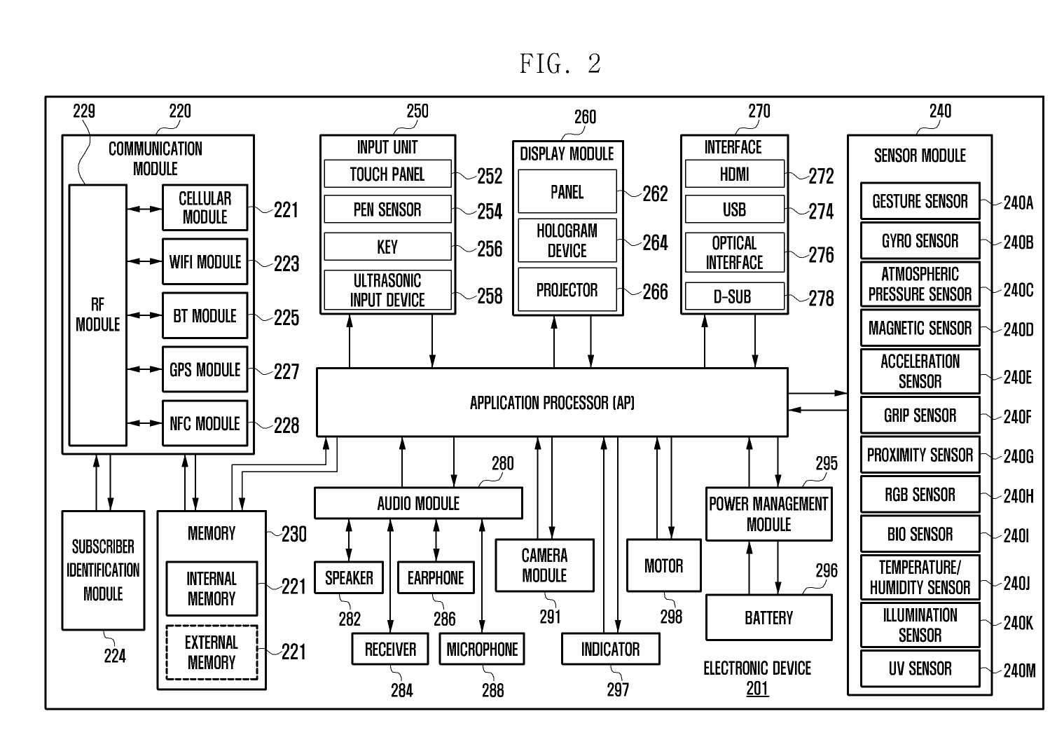

FIG. 2 is a block diagram illustrating an electronic device 201 according to an embodiment of the present disclosure.

The hardware shown in FIG. 2 may be, for example, the electronic device 101 illustrated in FIG. 1.

Referring to FIG. 2, the electronic device may include one or more processors 210, a communication module 220, a Subscriber Identification Module (SIM) card 224, a memory 230, a sensor module 240, an input device 250, a display module 260, an interface 270, an audio module 280, a camera module 291, a power management module 295, a battery 296, an indicator 297, a motor 298 and any other similar and/or suitable components.

The Application Processor (AP) 210 (e.g., the processor 120) may include one or more Application Processors (APs), or one or more Communication Processors (CPs). The processor 210 may be, for example, the processor 120 illustrated in FIG. 1. The AP 210 is illustrated as being included in the processor 210 in FIG. 2, but may be included in different Integrated Circuit (IC) packages, respectively. According to an embodiment of the present disclosure, the AP 210 may be included in one IC package.

The AP 210 may execute an Operating System (OS) or an application program, and thereby may control multiple hardware or software elements connected to the AP 210 and may perform processing of and arithmetic operations on various data including multimedia data. The AP 210 may be implemented by, for example, a System on Chip (SoC). According to an embodiment of the present disclosure, the AP 210 may further include a Graphical Processing Unit (GPU) (not illustrated).

The AP 210 may manage a data line and may convert a communication protocol in the case of communication between the electronic device (e.g., the electronic device 101) including the hardware and different electronic devices connected to the electronic device through the network. The AP 210 may be implemented by, for example, a SoC. According to an embodiment of the present disclosure, the AP 210 may perform at least some of multimedia control functions. The AP 210, for example, may distinguish and authenticate a terminal in a communication network by using a subscriber identification module (e.g., the SIM card 224). Also, the AP 210 may provide the user with services, such as a voice telephony call, a video telephony call, a text message, packet data, and the like.

Further, the AP 210 may control the transmission and reception of data by the communication module 220. In FIG. 2, the elements such as the AP 210, the power management module 295, the memory 230, and the like are illustrated as elements separate from the AP 210. However, according to an embodiment of the present disclosure, the AP 210 may include at least some (e.g., the CP) of the above-described elements.

According to an embodiment of the present disclosure, the AP 210 may load, to a volatile memory, a command or data received from at least one of a non-volatile memory and other elements connected to each of the AP 210, and may process the loaded command or data. Also, the AP 210 may store, in a non-volatile memory, data received from or generated by at least one of the other elements.

The SIM card 224 may be a card implementing a subscriber identification module, and may be inserted into a slot formed in a particular portion of the electronic device 101. The SIM card 224 may include unique identification information (e.g., Integrated Circuit Card IDentifier (ICCID)) or subscriber information (e.g., International Mobile Subscriber Identity (IMSI)).

The memory 230 may include an internal memory 232 and an external memory 234. The memory 230 may be, for example, the memory 130 illustrated in FIG. 1. The internal memory 232 may include, for example, at least one of a volatile memory (e.g., a Dynamic RAM (DRAM), a Static RAM (SRAM), a Synchronous Dynamic RAM (SDRAM), etc.), and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, a Not OR (NOR) flash memory, etc.). According to an embodiment of the present disclosure, the internal memory 232 may be in the form of a Solid State Drive (SSD). The external memory 234 may further include a flash drive, for example, a Compact Flash (CF), a Secure Digital (SD), a Micro-Secure Digital (Micro-SD), a Mini-Secure Digital (Mini-SD), an extreme Digital (xD), a memory stick, or the like.

The communication module 220 may include a cellular module 221, a wireless (WiFi) communication module 223 or a Radio Frequency (RF) module 229. The communication module 220 may be, for example, the communication interface 170 illustrated in FIG. 1. The communication module 220 may include, for example, a Wi-Fi part 223, a BT part 225, a GPS part 227, or a NFC part 228. For example, the wireless communication module 220 may provide a wireless communication function by using a radio frequency. Additionally or alternatively, the wireless communication module 220 may include a network interface (e.g., a LAN card), a modulator/demodulator (modem), or the like for connecting the hardware to a network (e.g., the Internet, a LAN, a WAN, a telecommunication network, a cellular network, a satellite network, a POTS, or the like).

The RF module 229 may be used for transmission and reception of data, for example, transmission and reception of RF signals or called electronic signals. Although not illustrated, the RF unit 229 may include, for example, a transceiver, a Power Amplifier Module (PAM), a frequency filter, a Low Noise Amplifier (LNA), or the like. Also, the RF module 229 may further include a component for transmitting and receiving electromagnetic waves in a free space in a wireless communication, for example, a conductor, a conductive wire, or the like.

The sensor module 240 may include, for example, at least one of a gesture sensor 240A, a gyro sensor 240B, an barometer sensor 240C, a magnetic sensor 240D, an acceleration sensor 240E, a grip sensor 240F, a proximity sensor 240G, a Red, Green and Blue (RGB) sensor 240H, a biometric sensor 2401, a temperature/humidity sensor 240J, an illuminance sensor 240K, and a

Ultra Violet (UV) sensor 240M. The sensor module 240 may measure a physical quantity or may sense an operating state of the electronic device 101, and may convert the measured or sensed information to an electrical signal. Additionally/alternatively, the sensor module 240 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), a fingerprint sensor (not illustrated), and the like. Additionally or alternatively, the sensor module 240 may include, for example, an E-nose sensor (not illustrated), an EMG sensor (not illustrated), an EEG sensor (not illustrated), an ECG sensor (not illustrated), a fingerprint sensor, and the like. The sensor module 240 may further include a control circuit (not illustrated) for controlling one or more sensors included therein.

The input device 250 may include a touch panel 252, a pen sensor 254 (e.g., a digital pen sensor), keys 256, and an ultrasonic input unit 258. The input device 250 may be, for example, the input/output interface 150 illustrated in FIG. 1. The touch panel 252 may recognize a touch input in at least one of, for example, a capacitive scheme, a resistive scheme, an infrared scheme, and an acoustic wave scheme. Also, the touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user.

The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input unit 258 enables the terminal to sense a sound wave by using a microphone (e.g., a microphone 288) of the terminal through a pen generating an ultrasonic signal, and to identify data. The ultrasonic input unit 258 is capable of wireless recognition. According to an embodiment of the present disclosure, the hardware may receive a user input from an external device (e.g., a network, a computer, or a server), which is connected to the communication module 220, through the communication module 220.

The display module 260 may include a panel 262, a hologram 264, or projector 266. The display module 260 may be, for example, the display module 160 illustrated in FIG. 1. The panel 262 may be, for example, a Liquid Crystal Display (LCD) and an Active Matrix Organic Light Emitting Diode (AM-OLED) display, and the like. The panel 262 may be implemented so as to be, for example, flexible, transparent, or wearable. The panel 262 may include the touch panel 252 and one module. The hologram 264 may display a three-dimensional image in the air by using interference of light. According to an embodiment of the present disclosure, the display module 260 may further include a control circuit for controlling the panel 262 or the hologram 264.

The interface 270 may include, for example, a High-Definition Multimedia Interface (HDMI) 272, a Universal Serial Bus (USB) 274, an optical interface 276, and a D-subminiature (D-sub) 278. Additionally or alternatively, the interface 270 may include, for example, SD/Multi-Media Card (MMC) (not illustrated) or Infrared Data Association (IrDA) (not illustrated).

The audio module 280 may bidirectionally convert between a voice and an electrical signal. The audio module 280 may convert voice information, which is input to or output from the audio module 280, through, for example, a speaker 282, a receiver 284, an earphone 286, the microphone 288 or the like.

The camera module 291 may capture an image and a moving image. According to an embodiment, the camera module 291 may include one or more image sensors (e.g., a front lens or a back lens), an Image Signal Processor (ISP) (not illustrated), and a flash LED (not illustrated).

The power management module 295 may manage power of the hardware. Although not illustrated, the power management module 295 may include, for example, a Power Management Integrated Circuit (PMIC), a charger Integrated Circuit (IC), or a battery fuel gauge.

The PMIC may be mounted to, for example, an IC or a SoC semiconductor. Charging methods may be classified into a wired charging method and a wireless charging method. The charger IC may charge a battery, and may prevent an overvoltage or an overcurrent from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and the like. Additional circuits (e.g., a coil loop, a resonance circuit, a rectifier, etc.) for wireless charging may be added in order to perform the wireless charging.

The battery fuel gauge may measure, for example, a residual quantity of the battery 296, or a voltage, a current or a temperature during the charging. The battery 296 may supply power by generating electricity, and may be, for example, a rechargeable battery.

The indicator 297 may indicate particular states of the hardware or a part (e.g., the AP 211) of the hardware, for example, a booting state, a message state, a charging state and the like. The motor 298 may convert an electrical signal into a mechanical vibration. The processor 210 may control the sensor module 240.

Although not illustrated, the hardware may include a processing unit (e.g., a GPU) for supporting a module TV. The processing unit for supporting a module TV may process media data according to standards such as, for example, Digital Multimedia Broadcasting (DMB), Digital Video Broadcasting (DVB), media flow, and the like. Each of the above-described elements of the hardware according to an embodiment of the present disclosure may include one or more components, and the name of the relevant element may change depending on the type of electronic device. The hardware according to an embodiment of the present disclosure may include at least one of the above-described elements. Some of the above-described elements may be omitted from the hardware, or the hardware may further include additional elements. Also, some of the elements of the hardware according to an embodiment of the present disclosure may be combined into one entity, which may perform functions identical to those of the relevant elements before the combination.

The term “module” used in the present disclosure may refer to, for example, a unit including one or more combinations of hardware, software, and firmware. The “module” may be interchangeable with a term, such as “unit,” “logic,” “logical block,” “component,” “circuit,” or the like. The “module” may be implemented mechanically or electronically. For example, the “module” according to an embodiment of the present disclosure may include at least one of an Application-Specific Integrated Circuit (ASIC) chip, a Field-Programmable Gate Array (FPGA), and a programmable-logic device for performing certain operations which have been known or are to be developed in the future.

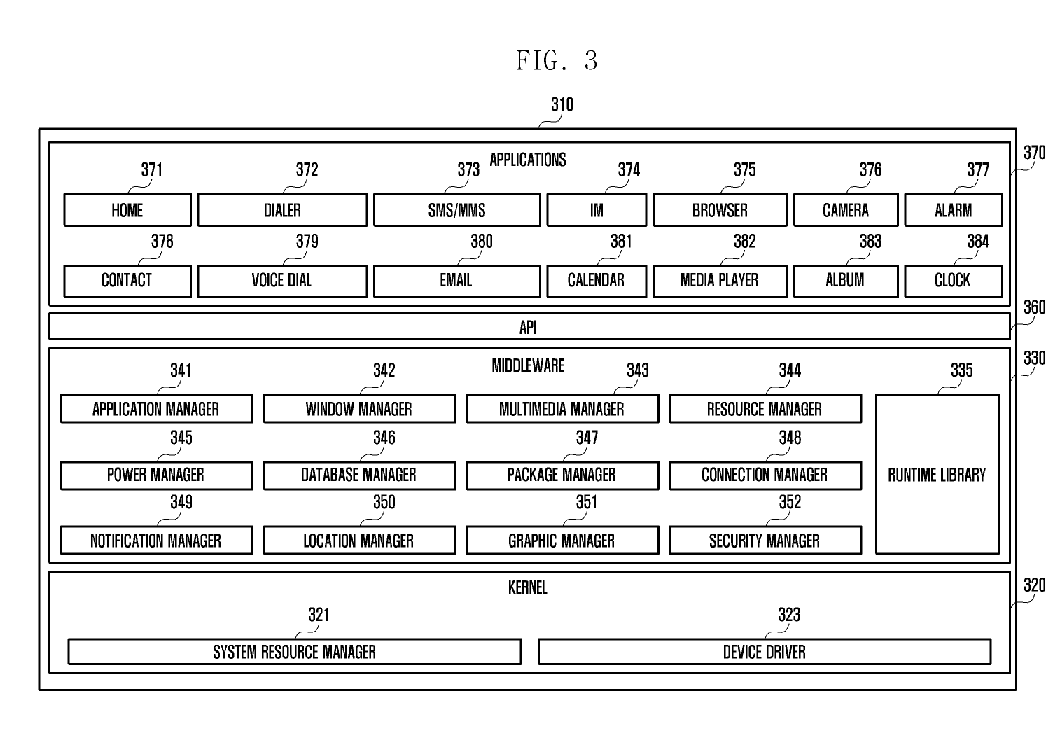

FIG. 3 is a block diagram illustrating one or more programming modules 300 according to an embodiment of the present disclosure.

The programming module 300 may be included (or stored) in the electronic device 101 (e.g., the memory 130) or may be included (or stored) in the electronic device 201 (e.g., the memory 230) illustrated in FIG. 1. At least a part of the programming module 300 may be implemented in software, firmware, hardware, or a combination of two or more thereof. The programming module 300 may be implemented in hardware (e.g., the hardware), and may include an OS controlling resources related to an electronic device (e.g., the electronic device 101) and/or various applications (e.g., an application 370) executed in the OS. For example, the OS may be Android, iOS, Windows, Symbian, Tizen, Bada, and the like.

Referring to FIG. 3, the programming module 300 may include a kernel 310, a middleware 330, an API 360, and/or the application 370.

The kernel 310 (e.g., the kernel 131) may include a system resource manager 311 and/or a device driver 312. The system resource manager 311 may include, for example, a process manager (not illustrated), a memory manager (not illustrated), and a file system manager (not illustrated). The system resource manager 311 may perform the control, allocation, recovery, and/or the like of system resources. The device driver 312 may include, for example, a display driver (not illustrated), a camera driver (not illustrated), a Bluetooth driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 312 may include an Inter-Process Communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a Basic Input/Output System (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 101) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 133) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 134) may include, for example, a preloaded application and/or a third party application. The applications 370 (e.g., the applications 134) may include, for example, a home application 371, a dialer application 372, a Short Message Service (SMS)/Multimedia Message Service (MMS) application 373, an Instant Message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 300 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 230. At least a part of the programming module 300 may be implemented (e.g., executed) by, for example, the one or more processors 210. At least a part of the programming module 300 may include, for example, a module, a program, a routine, a set of instructions, and/or a process for performing one or more functions.

Names of the elements of the programming module (e.g., the programming module 300) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements. The operations performed by the programming module or other elements according to an embodiment of the present disclosure may be processed in a sequential method, a parallel method, a repetitive method, or a heuristic method. Also, some of the operations may be omitted, or other operations may be added to the operations.

An electronic device according to one embodiment of the present disclosure includes a display including a first area having a first pixel controlled by a first signal and powered by a first power supply and a second area having a second pixel controlled by a second signal and powered by a second power supply; and a biometric sensor disposed in the first area and configured to acquire biometric information. The first signal may include a signal for changing luminance, color, or brightness corresponding to the first pixel. The first signal may include a signal for changing power supplied by the first power supply. The power supplied by the first power supply may include a first ELVSS voltage and a first ELVDD voltage that are supplied to the first pixel, and the power supplied by the second power supply may include a second ELVSS voltage and a second ELVDD voltage that are supplied to the second pixel. The first ELVSS voltage may have no potential difference from the first ELVDD voltage when the biometric sensor is activated. The first signal may include an EM signal for turning on the first pixel. The EM signal may not be supplied to the first pixel when the biometric sensor is activated.

In addition, an electronic device according to one embodiment of the present disclosure includes a display configured to include a display area and a non-display area; a biometric sensor disposed in at least a part of the display area of the display; and a processor configured to control the display and the biometric sensor, where the display area includes a first area corresponding to a location of the biometric sensor and a second area separate from the first area, and where, if a touch or hover input from a user to the first area is sensed, the processor may be further configured to differently control driving states of the first and second areas, and acquire biometric information of the user using the biometric sensor. The biometric sensor includes a light emitting element that is disposed under the display or embedded in the display and a light receiving element that is disposed under the display or embedded in the display, and to control the driving state of the first area, the processor may be further configured to turn off one or more pixels in the first area. The one or more pixels are organic light emitting diodes, and to turn off the one or more pixels in the first area, the processor may be further configured to control an ELVSS voltage supplied to the one or more pixels in the first area so that the ELVSS voltage has no potential difference from an ELVDD voltage.

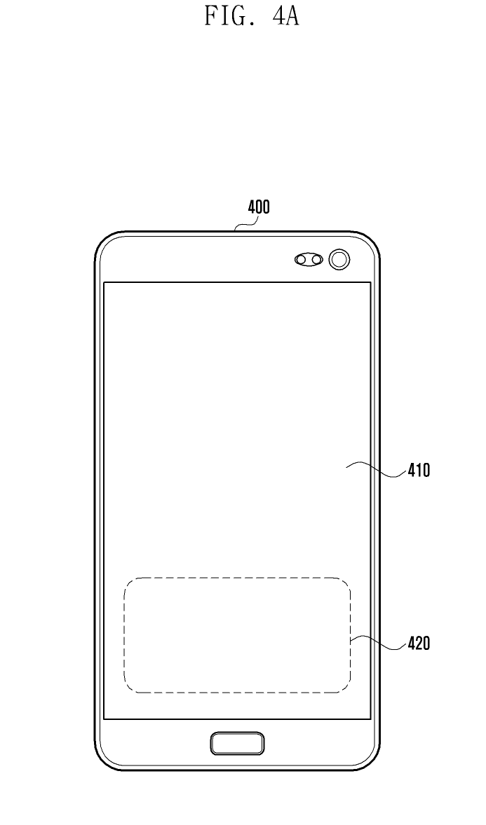

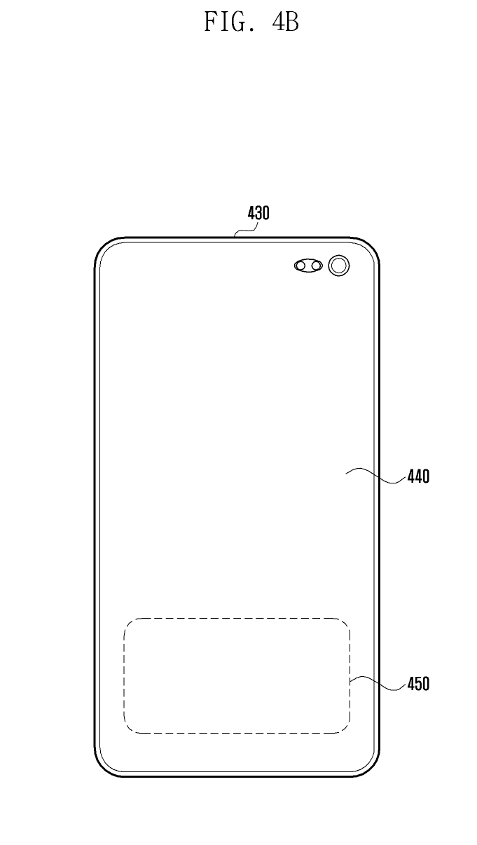

FIGS. 4A and 4B are diagrams illustrating an electronic device according to an embodiment of the present disclosure.

Referring to FIG. 4A, an electronic device 400 (e.g., electronic device 101) may include a biometric sensor (e.g., fingerprint sensor) for recognizing biometric information (e.g., fingerprint information) in at least a part of a display 410 (e.g., display 160). The biometric sensor 420 is formed in at least a part (e.g., active area or black matrix (BM) area of the display) of the display 410 and it may be configured to acquire the user's biometric information when the user enters an input to the display 410.

Referring to FIG. 4B, in an electronic device 430 (e.g., electronic device 101), a biometric sensor 450 is included in at least a part of a display 440 (e.g., display 160) such that the area occupied by the biometric sensor 450 is within the area of as the display 440. In this case, the size of the display may be expanded and the bezels may be minimized.

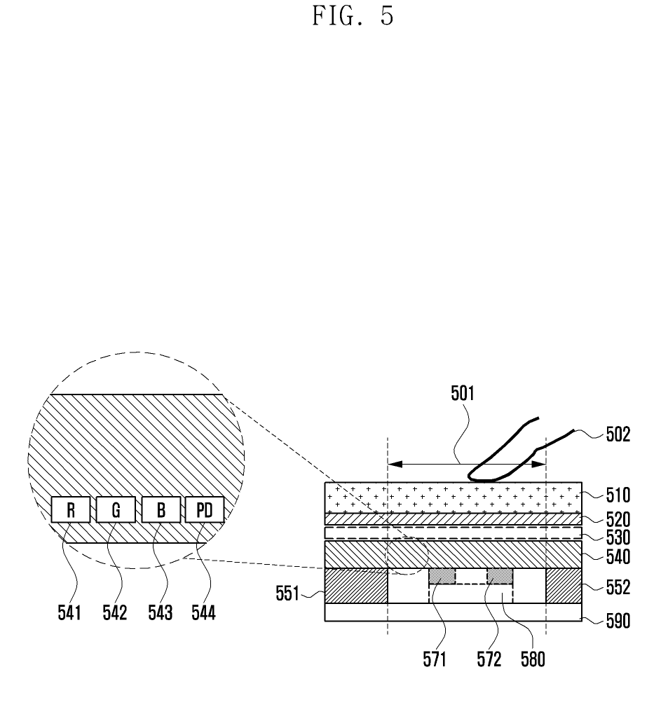

FIG. 5 illustrates a structure in which a biometric sensor (e.g., biometric sensor 420 of FIG. 4A or the biometric sensor 450 of FIG. 4B) for sensing user's biometric information that is mounted in an area of a display 540 of an electronic device (e.g., electronic device 400 of FIG. 4A or electronic device 430 of FIG. 4B) according to an embodiment of the present disclosure.

Referring to FIG. 5, the electronic device may include glass 510, a biometric sensor 530, a display 540, a biometric sensor 580, or a PCB 590. The glass 510 may adhere to the biometric sensor 530 or the display 540 by an adhesive 520. According to one embodiment, the electronic device may further include structures 551 and 552 for providing a mounting space of the biometric sensor 580. The structures 551 and 552 may be part of a sealing structure for protecting the biometric sensor 580.

The biometric sensors 530 and 580 may be formed in a partial area (e.g., one area or a plurality of areas) of the display 540, or over the whole area of the display (e.g., the entire active area of a display).

The biometric sensors 530 and 580 capable of sensing fingerprint information may be formed on one surface (e.g., upper surface) (e.g., separate layer 530 on one surface of the display 540, at least some area of a surface on which the pixels 541 to 543 of the display are formed, etc.) of the display 540. The biometric sensors 530, 544, and 580 may be, for example, an optical type image sensor, an ultrasonic type sensor, or a capacitive type sensor.

The biometric sensor 530 may be formed between the adhesive layer 520 and the display 540, or between the glass 510 and the adhesive layer 520. When the biometric sensor 530 is a capacitive type sensor, it may include transparent electrodes in order to increase transmittance of light output from the display 540.

Elastic bodies 571 and 572 (e.g., sponge or rubber) may be formed between the biometric sensor 580 and the display 540 to reduce shocks or prevent foreign substances from being introduced between the biometric sensor 580 and the display 540. When the biometric sensor 580 is an image sensor, the image sensor may output light (e.g., visible light or infrared light) from a light source (e.g., display 540 or an IR LED (infrared light emitting diode)) to the user's finger, and sense light reflected from the user' finger in order to detect the user's fingerprint.

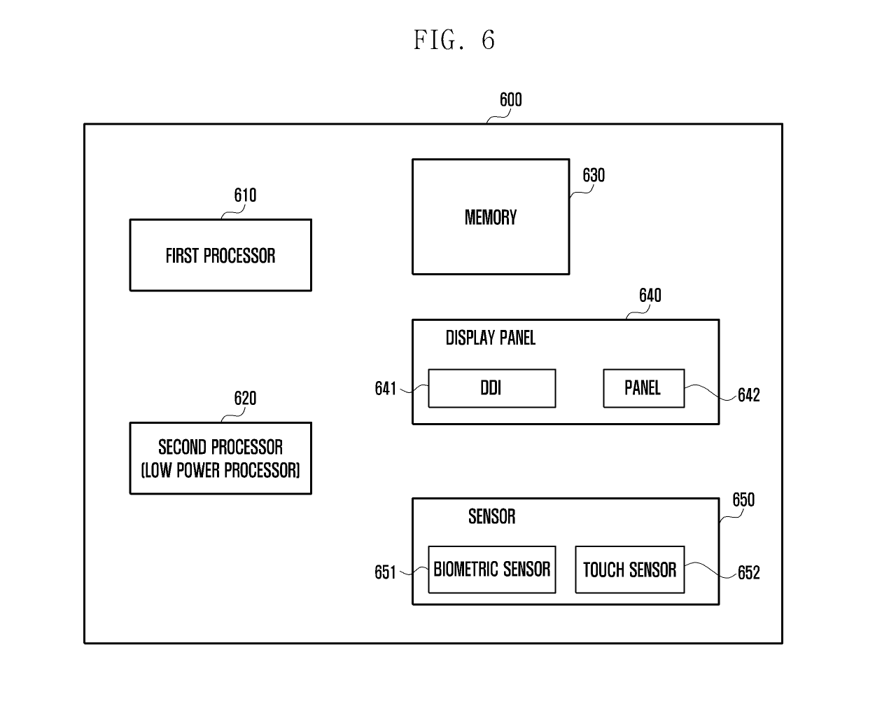

FIG. 6 is a block diagram illustrating an electronic device according to one embodiment of the present disclosure.

Referring to FIG. 6, the electronic device 600 (e.g., the electronic device 400 of FIG. 4A or the electronic device 430 of FIG. 6B) includes at least one processor (e.g., first processor 610 or second processor 620), a memory 630, a display 640, or at least one sensor 650.

According to one embodiment, the first processor 610 may control the overall operation of the electronic device 600. The second processor 620 (e.g., low power processor, or sensor HUB) may be process the sensor information acquired through the at least one sensor 650 without waking up the first processor 610 if the first processor 610 or the electronic device 600 is in sleep state.

The second processor 620 may control the biometric sensor 651, the touch sensor 652, and/or the display 640 independently of the first processor 610.

The memory 630 may include a general area for storing user applications and the like, and a security area for storing sensitive information such as biometric data used to identify or authenticate the user.

The display 640 may include a display panel 642 including a plurality of pixels and a display driving module (e.g., display driver IC (DDI) 641) configured to control at least some of the pixels to provide display information. According to one embodiment, the sensor 650 may include a biometric sensor 651 (e.g., biometric sensor 450) for sensing the user's fingerprint placed on the display module 640 or a touch sensor 652 for sensing the user's touch placed on the display module 640. According to one embodiment, the biometric sensor 651 may include an optical fingerprint sensor (e.g., image sensor) that uses light output from the display module as a light source.

According to an embodiment, the sensor 650 may drive a plurality of pixels included in the display panel 642 via the display driving module 641 in response to an input from the user. In other words, the sensor 650 may control the display panel 642 as needed. For example, the biometric sensor 651 may control the display panel 642 to emit light so as to acquire the user's biometric information.

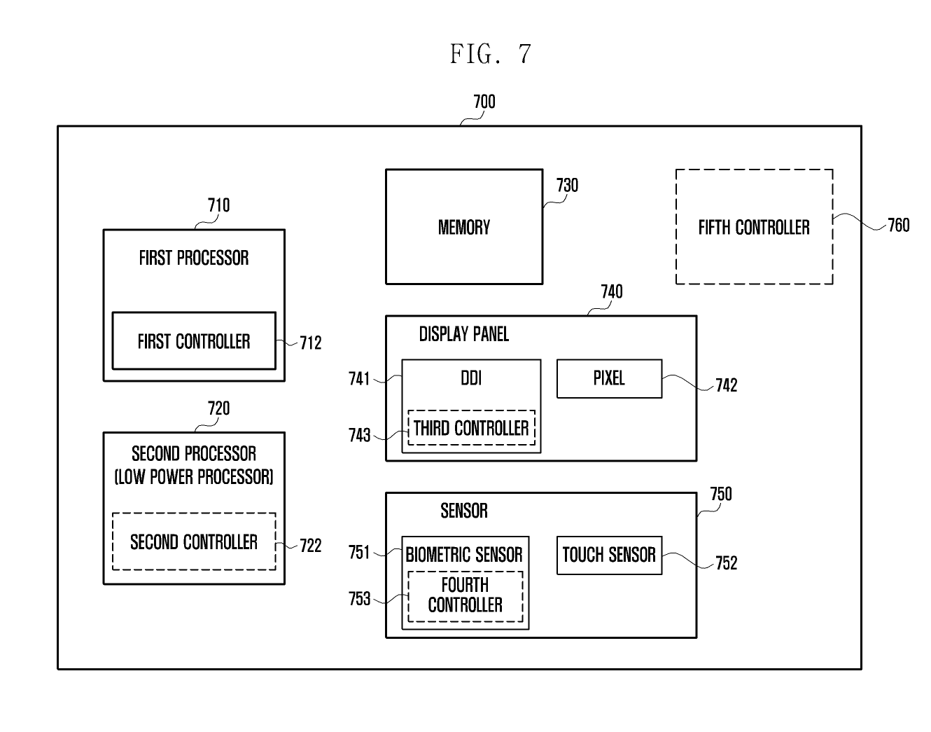

FIG. 7 is a block diagram illustrating an electronic device according to another embodiment of the present disclosure.

According to this other embodiment, an electronic device 700 (e.g., the electronic device 400 of FIG. 4A or the electronic device 430 of FIG. 4B) includes a plurality of controllers (e.g., first controller 712, second controller 722, third controller 743, fourth controller 753, fifth controller 760, or the like), in which some of the controllers are included in various modules such as the first processor 710, second processor 720, DDI 741, or biometric sensor 751 of the electronic device 700. For example, the electronic device 700 may control the first processor 710 using the first controller 712 and the second processor 720 using the second controller 722. In addition, the electronic device 700 may control the modules containing the third controller 743 and the fourth controller 753 using the third controller 743 and the fourth controller 753.

One controller may be used to control the modules of the electronic device 700. For example, the electronic device 700 may include a plurality of controllers (e.g., first controller 712, second controller 722, third controller 743, and fourth controller 753) that are controlled by a main controller (e.g., fifth controller 760). Further, the electronic device 700 may change the designation of the main controller. For example, the electronic device 700 may change/designate the main controller from the fifth controller 760 to the first controller 712, and may control other controllers using the first controller 712.

One controller may also be used to directly control the modules of the electronic device 700. For example, the electronic device 700 may control the second processor 720, the memory 730, the display 740, and/or at least one sensor 750 using the first controller 712 included in the first processor 710. According to another embodiment, the display 740 and the sensor 750 may be controlled by one controller. For example, in the case where the sensor 750 is an optical fingerprint sensor that uses the display 740 as a light source, the display 740 and the sensor 750 may be controlled using one controller, and the user's biometric information may be easily acquired.

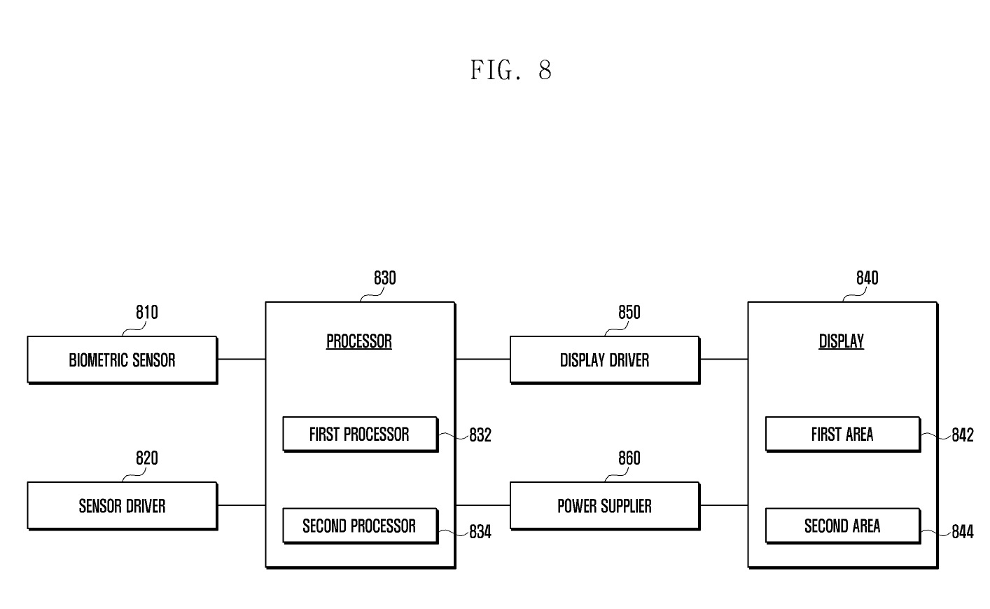

FIG. 8 is a block diagram illustrating an electronic device according to an embodiment of the present disclosure.

Referring to FIG. 8, an electronic device (e.g., the electronic device 400 of FIG. 4A or the electronic device 430 of FIG. 4B) according to one embodiment of the present disclosure may include a biometric sensor 810 (e.g., biometric sensor 751), a sensor driver 820 (e.g., fourth controller 753), a processor 830, a display 840 (e.g., display 740), a display driver 850 (e.g., DDI 741), and a power supplier 860.

The biometric sensor 810 may be a proximity sensor, an illuminance sensor, a fingerprint sensor, an iris sensor, etc. According to one embodiment, the biometric sensor 810 may be an optical sensor that uses invisible light as a light source. The invisible light may be, for example, light in a wavelength band outside the visible band. For example, the invisible light may include infrared light. As explained above, at least a part of the biometric sensor 810 may be disposed in the display area of the display 840. For example, the display 840 may be a touchscreen, and the fingerprint sensor may be disposed in a part of the display area of the display 840 so as to detect fingerprint information when the user enters touch input on the display 840.

The sensor driver 820 may drive the biometric sensor 810. The sensor driver 820 may transmit the user's biometric information sensed by the biometric sensor 810 to the processor 830. The different sensor driver 820 may be provided for each kind of the biometric sensors 810. Alternatively, the sensor driver 820 may be configured as a single chip capable of driving a number of different types of biometric sensors. A portion or all of the sensor drivers 820 may be implemented in the processor 830 or the display driver 850.

The processor 830 may control each component of the electronic device. As illustrated in FIG. 1, the processor 830 may have the same or similar configuration as the processor 120. The processor 830 may include a first processor 832 (e.g., first processor 710) and a second processor 834 (e.g., second processor 720). The first processor 832 may control the overall operation of the electronic device. The second processor 834 may process information obtained via the biometric sensor 810 without waking up the first processor. According to one embodiment, the second processor 834 may control the biometric sensor 810, the touch sensor (e.g., a touch sensor 752), or the display 840 independently of the first processor 832.

The display 840 may be an organic light emitting diode display. According to one embodiment, the display 840 may include a display area and a non-display area. The display area may also be divided into a first area 442 in which the sensor 810 is disposed and a second area 844 apart from the first area 842. For example, a fingerprint sensor may be disposed in the first area 842. The fingerprint sensor may be embedded in the display area of the display 840 or may be disposed under the display area. When the fingerprint sensor is an optical sensor that optically sense a user's fingerprint, it may utilize light emitted from the display area of the display 840 or may include its own light emitting element separately from the display 840. The first area 842 may display content such as images, text, user interfaces, etc. under the control of the processor 830 or the display driver 850. The first area 842 may or may not display content in a sensing state of the electronic device. In the sensing state of the electronic device, the biometric sensor 810 disposed in the first area 842 may be activated. According to one embodiment, the biometric sensor 810 may periodically check whether user input is entered or whether a user's body part (e.g. a finger) is within a certain proximity of the electronic device (e.g. hovering input) when the electronic device is in sleep state and/or is locked. In the sleep state of the electronic device, the fingerprint sensor may be activated if touch or hovering input is detected. In the above description, the sleep state of the electronic device may be a low-power state or the locked state of the electronic device, where only a low power processor (e.g., second processor 834) and components necessary for detecting user input are powered.

According to one embodiment of the present disclosure, the second area 844 may content such as images, text, user interfaces, etc. under the control of the processor 830 or the display driver 850. The second area 844 may continuously provide content during the sensing state of the electronic device. In the sleep state of the electronic device however, the second area 844 under the control of the low power processor, for example, the second processor 834, may be powered off.

Thus, the first area 842 and the second area 844 may operate independently of each other. For example, if the electronic device is in the sleep state, the second processor 834 may turn off the second area 844 and turn on the first area 842. When the user's fingerprint is recognized using the biometric sensor 810 while only the first area 842 is turned on, the second processor 834 may turn on the second area 844 and cause the first processor 832 to be activated. In this way, recognition of the user's fingerprint may cause the electronic device to wake up. The display driver 850 may then drive the display 840 under the control of the processor 830. The display driver 850 may include an interface block that may transmit and receive commands or data to and from the application processor 830 (hereinafter, AP) or the second processor 834 (e.g., low-power processor 830, hereinafter, LLP), a graphic memory that may store content received from the AP or the LPP, a mixer that may control the signal paths of the data received from the interface block or the graphic memory, a processing module that may perform correction for the content to be displayed or processing of the biometric information, a memory that may store location information or address information of the first area 442, a mapping module that may process content to be displayed in the first area 842 and the second area 842 using the location information or the address information on the first area 842, and a source driver for driving the pixels of the display 440.

The power supplier 860 may supply driving voltages required to drive each component of the electronic device. For example, the power supplier 860 may convert a reference voltage provided from a battery to generate a plurality of driving voltages and supply the plurality of generated driving voltages to each component of the electronic device.

According to one embodiment, the power supplier 860 may supply separate driving voltages for the first area 842 and the second area 844. The power supplier 860 may be a single power supplier capable of providing a plurality of driving voltages to the first area 842 and the second area 844. Alternatively, the power supplier 860 may be implemented as a plurality of separate power suppliers for separately providing driving voltages to the first area 842 and the second area 844. For example, the power supplier 860 may include a first power supplier for controlling the driving voltage supplied to the first area 842 and a second power supplier for controlling the driving voltage supplied to the second area 844.

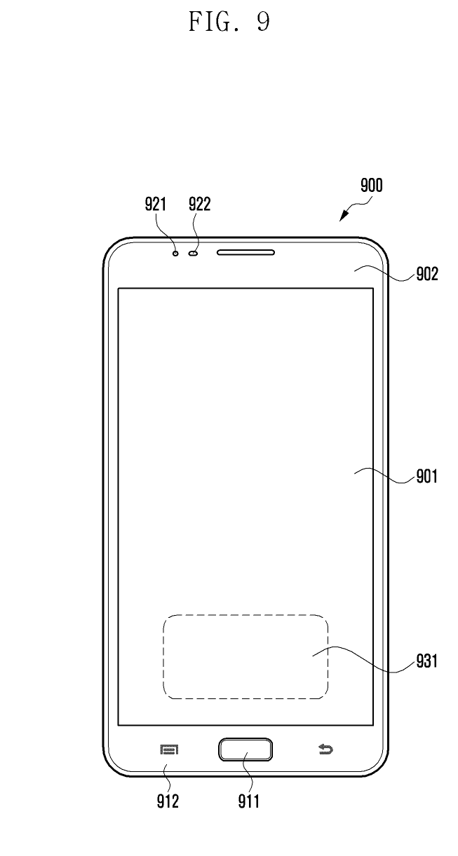

FIG. 9 is a diagram illustrating a front appearance of an electronic device according to an embodiment of the present disclosure.

Referring to FIG. 9, an electronic device 900 (e.g., electronic device 101) according to an embodiment of the present disclosure may have a display 901 (e.g., display 160) disposed on a front surface thereof. In the display 901, an area in which a screen is positioned may be called the display area. In the electronic device 900, the area other than the display area may be called the non-display area 902. For example, the non-display area 902 may be an area surrounding the display area of the display 901. Alternatively, the non-display area 902 may be called a bezel area on front of the electronic device 900.

According to one embodiment, in the non-display area 902 there may be buttons 911 and 912 for operating the electronic device 900. The one or more buttons may be formed in a separate hole or groove in the glass covering the front surface of the electronic device 900. One such button may be an operation key 911 that may be physically pressed. The operation key 911 may be, for example, a home button 911 provided in the non-display area 900 of the electronic device 902. The home button may be disposed in the lower non-display area 900 of the electronic device 902, as denoted by reference numeral 911. When the electronic device 900 performs a specific application, the home button 911 may move the specific application to an initial screen. Alternatively, the at least one button 912 may be a touch input button, unlike the home button 911, other buttons such as button 912 may be a soft-key button (e.g. a touch button).

The electronic device 900 may include biometric sensors 921, 922, and/or 931. Some of the biometric sensors may be disposed in the non-display area 902 or the display area. The biometric sensors may include proximity sensor 921, illuminance sensor 922, fingerprint sensor 931, or an iris sensor (not shown). For example, some of the plurality of biometric sensors 921 and 922 may be disposed in the non-display area 902, and the other sensor 931 may be disposed in the display area. The proximity sensor 921 may be disposed in the upper portion of the non-display area 902. The illuminance sensor 922 may also be disposed in the upper portion of the non-display area 902. The fingerprint sensor 931 may be disposed in the display area of the display 901.

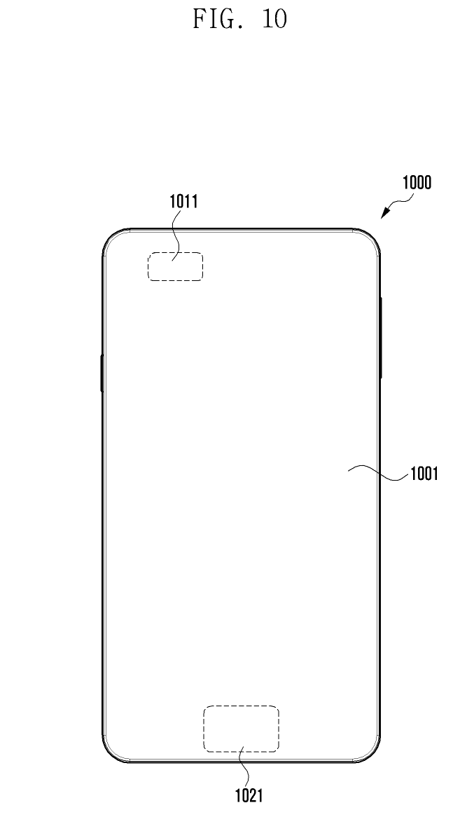

FIG. 10 is a diagram illustrating a front appearance of an electronic device according to another embodiment of the present disclosure.

Referring to FIG. 10, the front surface of an electronic device 1000 (e.g., electronic device 101) according to another embodiment of the present disclosure may be configured such that the display area 1001 covers substantially the entire front surface. In this case, the non-display area may be minimized so that it is non-existent or narrower compared to the non-display area shown in FIG. 9.

According to the embodiment, one or more parts of the display area 1001 may be provided with biometric sensors 1011 and 1021 (e.g., biometric sensor 651).

For example, the biometric sensors 1011 and 1021 may be a proximity sensor, an illuminance sensor, a fingerprint sensor, or an iris sensor. The proximity sensor and the illuminance sensor 1011 may be disposed in an upper part of the display area 1001. The fingerprint sensor 1021 may be disposed in a lower part of the display area. According to one embodiment, the area in which the biometric sensors 1011 and 1021 are disposed in the display area 1001 may be defined in advance, and address information of the predefined areas may be stored in the memory.

Thus, according to the present disclosure, at least one biometric sensor may be provided, in the display area 1001 of the display. Therefore, the present disclosure may reduce the margin or bezel around the display area. As such, the display area may be designed to be larger.

The biometric sensor disposed in the display area 1001 may optically recognize the user's biometric information. For example, the fingerprint sensor 1021 may be disposed in a first area of the display area 1001 of the display, and may optically sense the fingerprint information of the user.

According to one embodiment, the biometric sensors 1011 and 1021 may be integrally formed with the display. For example, the biometric sensors 1011 and 1021 may be disposed on at least one layer of the display. According to one embodiment, the biometric sensors 1011 and 1021 according to another embodiment of the present disclosure may be disposed to overlap with at least some area of the display area 1001 of the display, for example, an area denoted by reference numerals 1011 and 1021 in FIG. 10.

Either of the biometric sensors 1011 and 1021 may be fingerprint sensors that may include a light emitting element and a light receiving element. The light emitting element may emit light of a specific wavelength. If the light emitted from the light emitting element is reflected from the user's fingerprint, the light receiving element may recognize the fingerprint by sensing the reflected light. Hereinafter, for convenience of explanation, it is assumed that the biometric sensor 1021 disposed in the display area is the fingerprint sensor. However, the present disclosure is not so limited. For example, the biometric sensor 1021 may be a proximity sensor, an illumination sensor, an iris sensor, etc. The biometric sensor 1021 may be embedded among the pixels of the display. Alternatively, the biometric sensor 1021 may be implemented in a layer of the display separate from the layer housing the pixels.

If the fingerprint sensor is implemented in a separate layer, the fingerprint sensor layer may overlap with the layer housing the pixels. For example, the fingerprint sensor may be disposed under the thin film transistor and organic light emitting layers of the pixels. According to various embodiments, the display area 1001 may be divided into a first area in which at least one biometric sensor is disposed, and a second area other than the first area. The second area may be an area in which the biometric sensor is not disposed. For example, an area denoted by reference numerals 1011 and 1021 in FIG. 10 may be a first area as an area in which a biometric sensor is disposed. Alternatively, the area denoted by reference numeral 1001 in FIG. 10 may be the second area as the area in which the biometric sensor is not disposed.

Hereinafter, the reference numeral 1021 in FIG. 10 also denotes the first area where the biometric sensor 1021 is disposed, and the reference numeral 1001 in FIG. 10 also denotes the second area where no biometric sensors are disposed.

As disclosed above, during normal operations of the display (e.g. while the electronic device is awake), the first area 1021 may display content and collect fingerprint information of the user using the fingerprint sensor. Fingerprint information collection may occur during performance of a specific function of the electronic device, such as the user authentication function. During the sleep state of the electronic device on the other hand, the first area 1021 may not display content while still collecting fingerprint information.

The second area 1001 may be an area displaying content regardless of whether the electronic device is in its normal mode or executing a specific function (e.g. user authentication). For example, when the specific function is not executing, the first and second areas 1021 and 1001 both may display content. If the specific function is executed, the first area 1021 does not display content, but the fingerprint sensor is activated to collect fingerprint information of the user. However, the second area 1001 may still display content. But when the electronic device is in sleep mode, the second area 1001 may not display content. During the sleep state, an input of at least one button set for the unlocking may be detected.

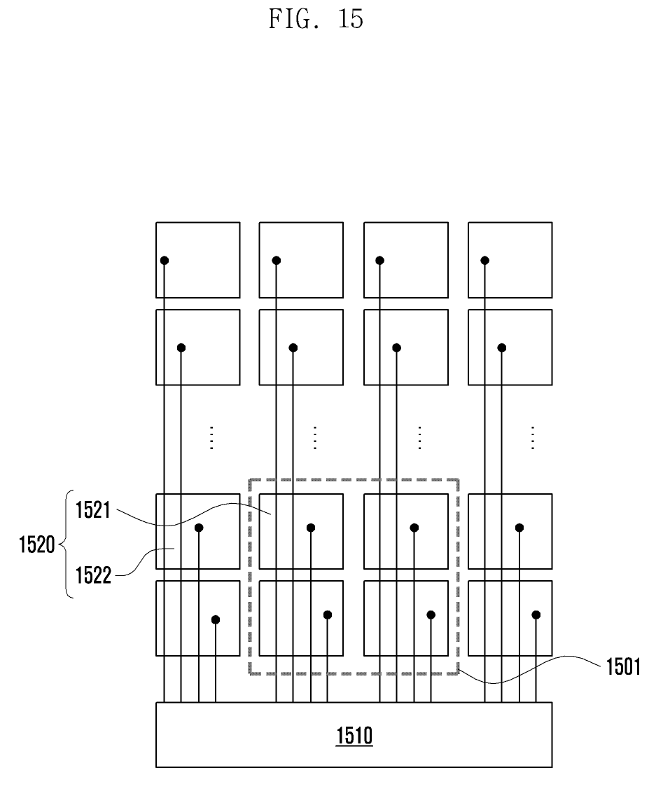

According to one embodiment, the electronic device 1000 may normally display content through the first area 1021 and the second area 1001, and then if fingerprint sensing is required, at least a part of the first area 1021 may be controlled differently. For example, when the user's touch occurs on the first area 1021, attributes of pixels corresponding to the area that the user touched may be changed. In further detail, in the area touched by the user, the electronic device 1000 may preferentially turning on the red (R) and green (G) sub-pixels and turn off the blue (B) sub-pixels. In another example, the electronic device 1000 may increase luminance of the pixels corresponding to the touch area so that the pixels can be used as a light source for fingerprint recognition. A partial area of the display may be dynamically controlled in response to the touch movement of the user. This may involve the operation of partially changing brightness of some areas of the display. These operations are disclosed in more detail below in connection with FIGS. 15-20.

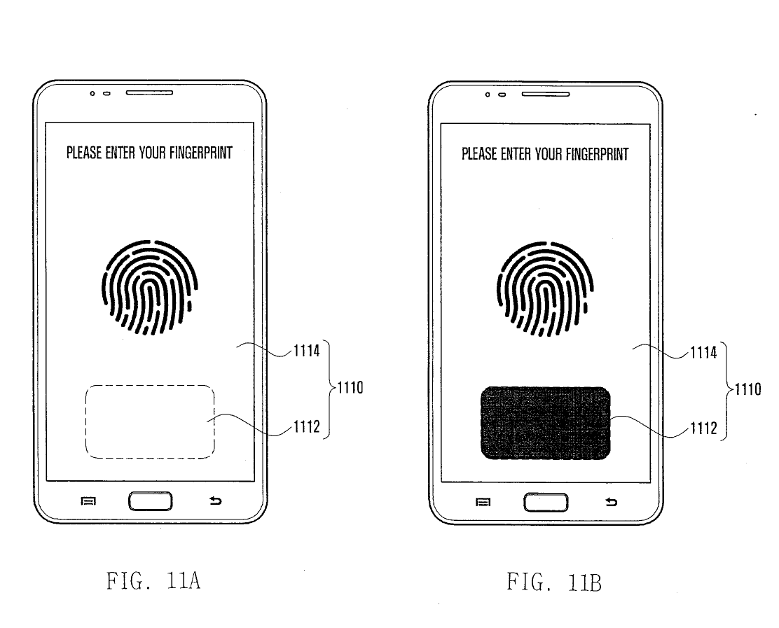

FIGS. 11 A and 11 B are diagrams illustrating a method of controlling a display while the electronic device according to an embodiment of the present disclosure senses fingerprint information.

According to one embodiment, depending on the operating state of a currently-executing application or on the input of the user, the electronic device (e.g., electronic device 101) may be in the sensing state. The sensing state of the electronic device may be a state in which the biometric user authentication is required. For example, the electronic device may switch to the sensing state upon execution of a mobile banking application to request fingerprint authentication. If authenticated, the user may use the mobile banking application. Alternatively, the electronic device may switch to the sensing state when login of a specific web site displayed by a web browser is required.

The sensing state of the electronic device may include a first state as illustrated in FIG. 11 A and a second state as illustrated in FIG. 11 B.

According to one embodiment of the disclosure, the electronic device may display a request for biometric information authentication and sense a touch or hovering input from the user to at least a part of the display 1110. For example, the electronic device may display a message requesting the user to enter his or her fingerprint in the second area 1114 of the display 1110 (e.g., display 160) in the first state, as shown in FIG. 11 A. In addition, the electronic device may sense the touch or hovering input of the user using the touch sensor disposed in the first area 1112 of the display 1110 in the first state.

If touch or hovering to at least a part of the display 1110 is sensed from the user, in the second state, the electronic device separately controls the first area 1112 of display 1110 to activate the biometric sensor for recognizing the user's biometric information. For example, if the electronic device senses touch or hovering input to the first area 1112 from the user, in the second state, the electronic device separately controls the first area 1112 of the display 1110 and activates the biometric sensor disposed in the first area 1112 to sense the fingerprint information of the user. In the above description, the operation of the electronic device to separately control the first area 1112 of the display 1110 may include turning off the display operation of the first area 1112.

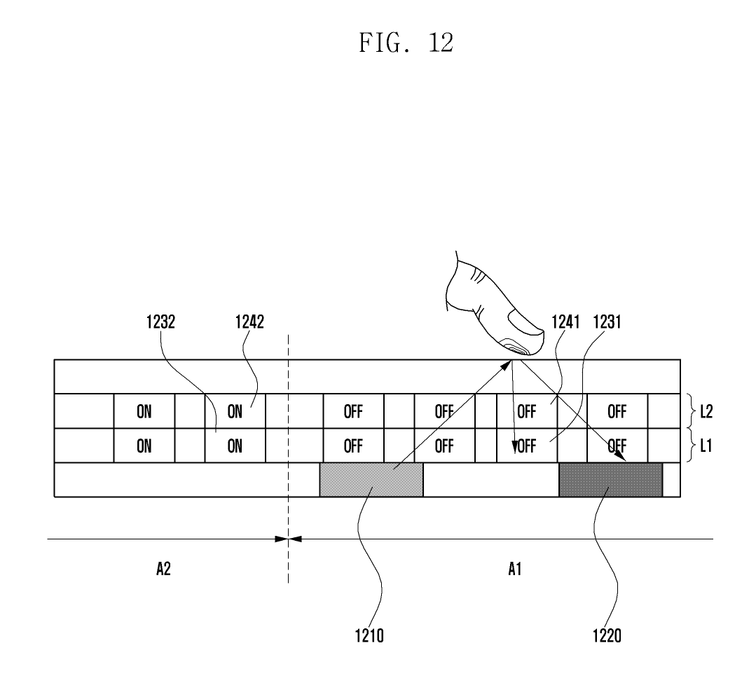

FIG. 12 is a diagram schematically illustrating a cross section of a display in the sensing state of the electronic device, according to an embodiment of the present disclosure.

According to an embodiment of the present disclosure, the electronic device (e.g., electronic device 101) includes an optical fingerprint sensor that is configured to include a light emitting element 1210 for outputting infrared light and a light receiving element 1220. The optical fingerprint sensor may be disposed in at least a part of the display area of the display (e.g., display 160). Therefore, if the light emitting element 1210 outputs infrared light, the infrared light may interfere with thin film transistors 1231 and 1232 provided in the pixel layer of the display. Specifically, the thin film transistors 1231 and 1232 may drive organic light emitting diodes 1241 and 1242. When the infrared light output from the light emitting element 1210 is incident on the thin film transistors 1231 and 1232, the thin film transistors 1231 and 1232 may malfunction. For example, if the thin film transistors 1231 and 1232 receive the light output from the light emitting element 1210 or the light reflected from the user's finger, a leakage current may be generated in the thin film transistors 1231 and 1232. This leakage current may cause the thin film transistors 1231 and 1232 to malfunction. For example, the leakage current may cause the corresponding OLED to erroneously turn on, thereby causing unwanted light leakage.

For example, as illustrated, the display includes a first layer L1 on which at least one thin film transistor 1231 and 1232 are formed, a second layer L2 positioned above the first layer L1 where organic light emitting diodes OLED 1241 and 1242 are formed. The light emitting element 1210 and the light receiving element 1220 may be positioned beneath the first layer L1.

To prevent the above-described malfunction, if touch or hovering input is sensed in the first area A1, the electronic device may turn off the thin film transistor corresponding to the first area A1 of the display and turn on the transistor of the second area A2. Accordingly, the organic light emitting diodes 1241 disposed in the first area Al may be turned off, and the organic light emitting diode 1242 disposed in the second area A2 may be turned on. In addition, the electronic device may activate the operation of the light emitting element 1210 and the light receiving element 1220 disposed in the first area Al to sense the fingerprint information of the user. At least a part of the light emitted from the light emitting element 1210 may be reflected from the user's fingerprint and supplied to the light receiving element 1220 while the light emitting element 1210 and the light receiving element 1220 are activated. To prevent the above-described leakage current, the electronic device according to an embodiment of the present disclosure may turn off the thin film transistor 1231 in the first area A1. This way, even when light from the light emitting element 1210 or light reflected from the user's finger is incident on the thin film transistor 1231, no leakage current is generated in the thin film transistor 1231.

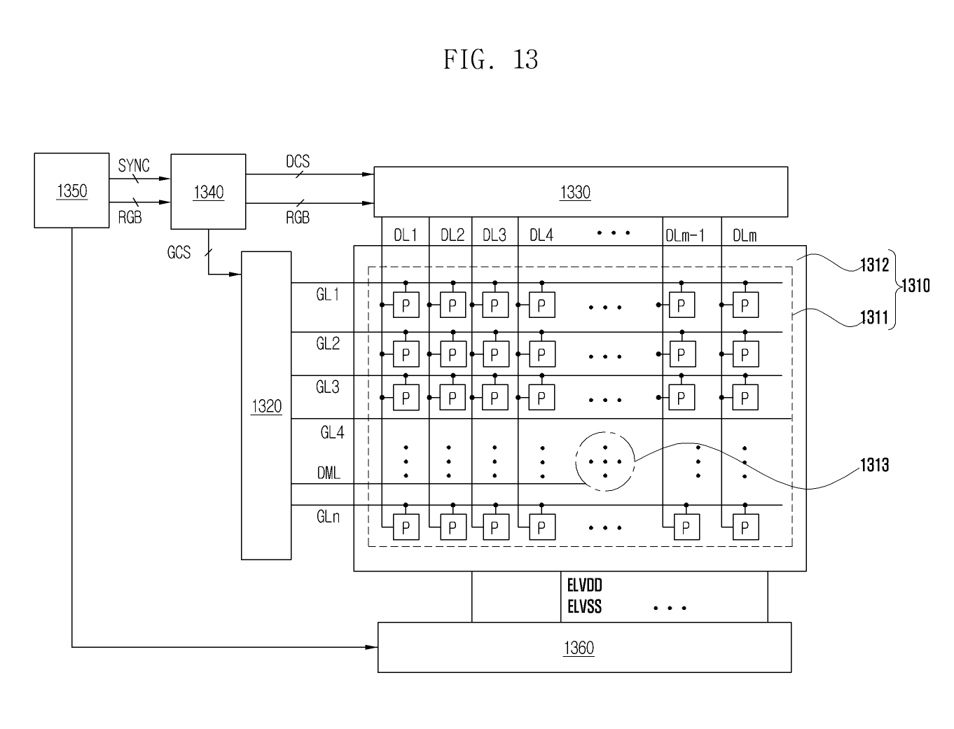

FIG. 13 is a circuit diagram illustrating a display and a display driver according to an embodiment of the present disclosure.

Referring to FIG. 13, a display 1310 (e.g., display 160) may include a display area 1311 and a non-display area 1312. The display 1310 may include a plurality of gate lines GL1 to GLn and a plurality of data lines DL1 to DLm that intersect with each other. Pixels P may be formed in areas where individual gate lines and data lines intersect. Each pixel P may include an organic light emitting diode (OLED) and a pixel driving circuit for driving the organic light emitting diode. The display driver (e.g., DDI 741) that drives display 1310 may include a gate driver 1320, a data driver 1330, a timing controller 1340, and an interface block 1350. The display area 1311 includes a first area 1313 in which the fingerprint sensor is disposed and the first area 1313 may include a separate dummy line (DML) connected to the gate driver 1320. The electronic device (e.g., electronic device 101) may supply a gate-off voltage only to the first area 1313 through the dummy line DML to turn off thin film transistors in the first area 1313.

The pixel driving circuits provided in each pixel P includes at least one thin film transistor (e.g., 1232 and 1231 in FIG. 12) and at least one capacitor. The thin film transistors may charge the capacitor with a data voltage supplied from the data line DL in response to a scan signal supplied from the gate line GL. The thin film transistors may control the amount of current supplied to the organic light emitting diode depending on the data voltage charged in the capacitor.

The gate driver 1320 may supply the scan signal to the plurality of gate lines GL1 to GLn according to at least one gate control signal GCS provided from the timing controller 1340. The gate driver 1320 may include a gate shift register that outputs the scan signal (also known as the scan pulse). The scan signal is sequentially supplied to each pixel. One or more scan signals may be provided to each individual pixel. If two or more scan signals are provided to each individual pixel, each gate line GL may be configured with a plurality of lines to supply a plurality of scan signals to each pixel.

The data driver 1330 may convert an image data RGB supplied from the timing controller 1340 into a data voltage depending on the data control signal DCS provided from the timing controller 1340. The data driver 1330 may generate the data voltage using a plurality of gamma compensation voltages. The data driver 1330 may sequentially supply the generated data voltage to the plurality of pixels using a line unit such as a row unit. The data driver 1330 may include a data shift register for outputting a sampling signal, a latch circuit for latching the image data into the row unit in response to the sampling signal, and a digital to analog converter for converting the latched image data into analog gradation voltages (pixel voltages).

The timing controller 1340 may align the image data RGB provided from the interface block 1350 according to the size and resolution of the display 1310. The timing controller 1340 may supply the data driver 1330 with the aligned image data (RGB). The timing controller 1340 may transmit a plurality of control signals GCS and DCS using a synchronization signal SYNC provided from the interface block 1350. GCS may be the gate control signal and DCS may be the data control signal. The gate control signal GCS may be a signal for controlling the drive timing of the gate driver 1320. The data control signal DCS may be a signal for controlling the drive timing of the data driver 1330. The synchronization signals SYNC may include a dot clock (DCLK), a data enable signal (DE), a horizontal synchronization signal (Hsync), a vertical synchronization signal (Vsync), or the like. According to one embodiment of the disclosure, the interface block 1350 may receive the image data (RGB) from a processor (e.g., processor 830 or application processor), and provides the received image data (RGB) to the timing controller 1340. The interface block 1350 may generate at least one synchronization signal SYNC and transmit the generated synchronization signal SYNC to the timing controller 1340. The interface block 1350 may control a power supplier 1360 (e.g., power supplier 860) to supply at least one drive voltage ELVDD and ELVSS to the display 1310.

According to one embodiment of the present disclosure, the power supplier 1360 may generate at least one driving voltage ELVDD and ELVSS necessary for driving the display 1310 and supply the generated driving voltages ELVDD and ELVSS to the display 1310. The power supplier 1360 may be configured as a single supplier or a plurality of suppliers to supply driving voltages ELVDD and ELVSS to the first area 1313 in which the fingerprint sensor is disposed and a second area other than the first area 1313. The power supplied to the first area 1313 and the second area may be independent of each other. In other words, power may be supplied to the first area 1313 while power is not supplied to the second area, and vice versa. The driving voltages may include, for example, ELVDD, ELVSS, a gate-on voltage, a gate-off voltage, or an initialization voltage. The gate-on voltage may be a voltage for turning on at least one thin film transistor included in the display. The gate-off voltage may be a voltage for turning off at least one thin film transistor included in the display. The initialization voltage may be a voltage for initializing the pixel driving circuit.

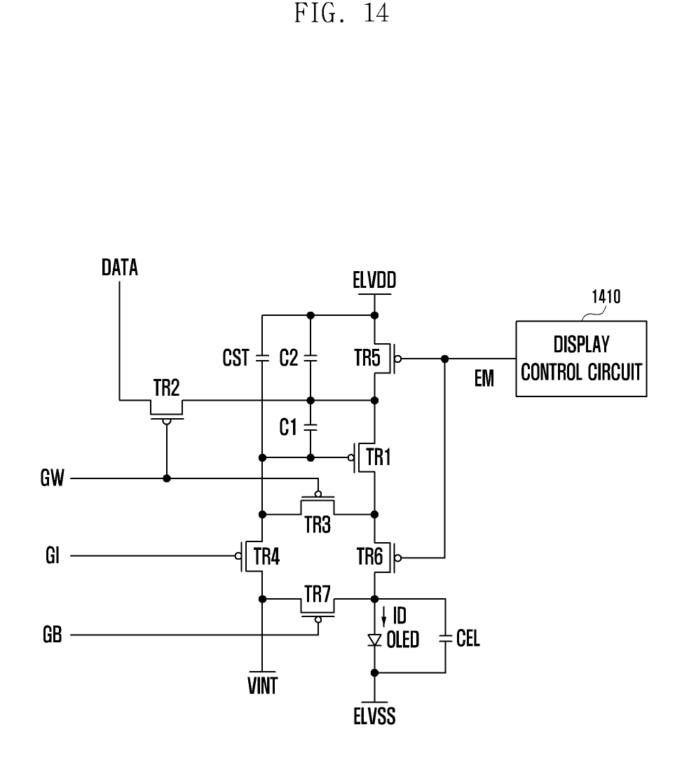

FIG. 14 is a circuit diagram illustrating a pixel driving circuit and an organic light emitting diode according to an embodiment of the present disclosure. According to one embodiment, the pixel driving circuit corresponding to each pixel of the display may be configured as illustrated in FIG. 14. Referring to FIG. 14, the pixel driving circuit may include seven thin film transistors TR1 to TR7, and one capacitor CST. The organic light emitting diode (OLED) is also shown in FIG. 14. The pixel driving circuit illustrated in FIG. 14 may have the advantage of improving process deviation of the thin film transistors TR1 to TR7 and the reaction speeds of the pixels. The pixel driving circuit illustrated in FIG. 14 is disclosed in Korean Patent Laid-Open Publication No. 10-2016-0024191, the entirety of which is incorporated by reference. Therefore, the detailed description of the pixel driving circuit illustrated in FIG. 14 will be omitted. The pixel structure of the present disclosure is not limited to the example of FIG. 14 and may be modified or changed. In the pixel driving circuit illustrated in FIG. 14, thin film transistors TR5 and TR6 may supply a driving current ID to the organic light emitting diode in response to an EM signal that triggers emission of the OLED. In such a pixel driving circuit, the display control circuit 1410 applies the EM signal so that the transistors TR5 and TR6 may be turned on to supply the driving current ID to the organic light emitting diode OLED. As described above, during the sensing state of the electronic device when the biometric sensor disposed in the first area of the display is activated, the display control circuit 1410 may not apply the EM signal to the pixels disposed in the first area (e.g., first area 1313) so that the transistors TR5 and TR6 of the pixels disposed in the first area are turned off. At the same time, the display control circuit 1410 applies the EM signal to the pixels disposed in the second area to turn on the transistors TR5 and TR6 of the pixels disposed in the second area. According to one embodiment, the display control circuit 1410 may be the gate driver 1320 illustrated in FIG. 13.

FIG. 15 is a block diagram illustrating an electrode and a power supply line for applying a driving voltage to a pixel in a display according to an embodiment of the present disclosure.

Referring to FIG. 15, the display may include a plurality of electrodes 1520 for applying driving voltages to pixels. For example, each electrode 1520 may be configured to supply the driving voltage to a plurality of pixels. In particular, one electrode 1520 illustrated in FIG. 15 may be arranged so as to overlap n×m pixels to supply driving voltages to n×m pixels P. The plurality of electrodes 1520 may be arranged in a matrix and each of the electrodes 1520 may be connected to the power supplier 1510. For example, each electrode 1520 may be directly connected to the power supplier 1510 through a power supply line. The power supplier 1510 may supply driving voltages, for example, ELVSS voltages, to each of the plurality of electrodes 1520 through the power supply lines.

According to one embodiment, the power supplier 1510 may vary at least one drive voltage supplied to the display. For example, the power supplier 1510 may vary the ELVSS voltage and supply the varied ELVSS voltages to various areas of the display. Specifically, the power supplier 1510 may supply a varied ELVSS voltage to the first area 1501 (e.g., first area A1) and a normal ELVSS voltage to the second area (e.g. second area A2) when the electronic device is in the sensing state. According to one embodiment, the varied ELVSS voltage may be a voltage having no potential difference from the ELVDD voltage.

For example, when the electronic device is in a sensing state, the power supplier 1510 may supply the varied ELVSS voltage to a plurality of first electrodes 1521 positioned in the first area 1501 and supply the normal ELVSS voltage to a plurality of second electrodes 1522 positioned in the second area. Accordingly, the electronic device may independently drive the electrodes in the first area and the second area.

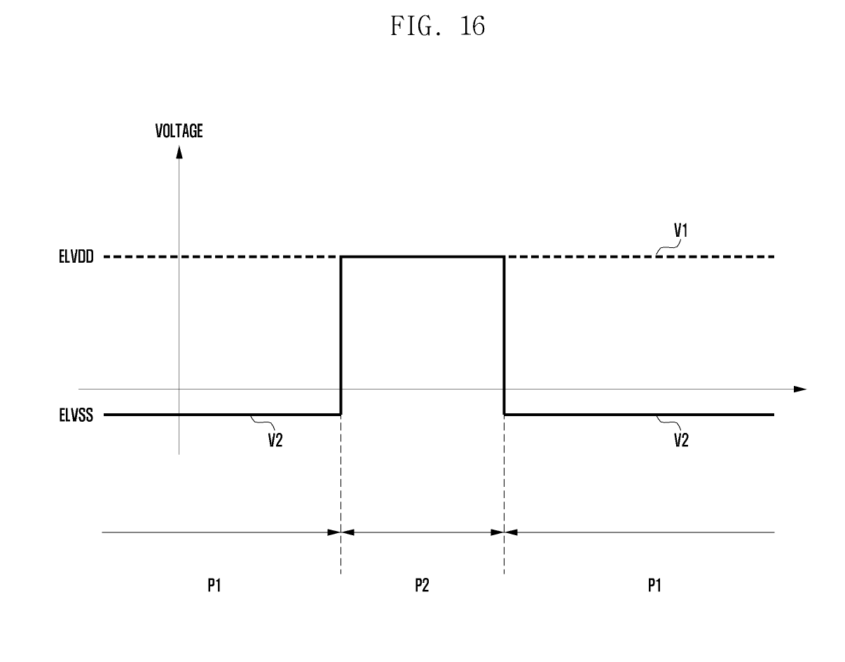

FIG. 16 is a diagram illustrating a driving voltage supplied to a display according to an embodiment of the present disclosure.

Referring to FIG. 16, the ELVDD voltage may be constant. According to one embodiment, during normal operation of the electronic device, the power supplier 1510 (e.g., power supplier 1360) may generate the ELVSS voltage and the ELVDD voltage such that there is a potential difference between the two. For example, the ELVDD voltage may have the V1 voltage level, and the ELVSS voltage may have the V2 voltage level, which is lower than V1. The power supplier 1510 may also change the ELVSS voltage so that there is no potential difference between ELVSS and ELVDD when the electronic device is in the sensing state. For example, the power supplier 1510 may change the ELVSS voltage from V2 to V1 when the electronic device is in the sensing state.

For example, when the electronic device is in the sensing state, shown as period P2 in FIG. 16, the power supplier 1510 may supply the varied ELVSS voltage to the pixels in the first area Al and supply the normal ELVSS voltage to the pixels in the second area A2. On the other hand, during normal operation of the electronic device, the power supplier 1510 may supply the normal ELVSS voltage to all of the pixels of the display. When the varied ELVSS voltage is applied to pixels in the first area A1, the pixel driving circuits (e.g., 1231 in FIG. 12) and the organic light emitting diodes (e.g., 1241 in FIG. 12) of the corresponding pixels may be turned off. Therefore, when the electronic device drives the optical fingerprint sensor during its sensing state, unintended leakage current and light leakage in the first area A1 may be prevented.

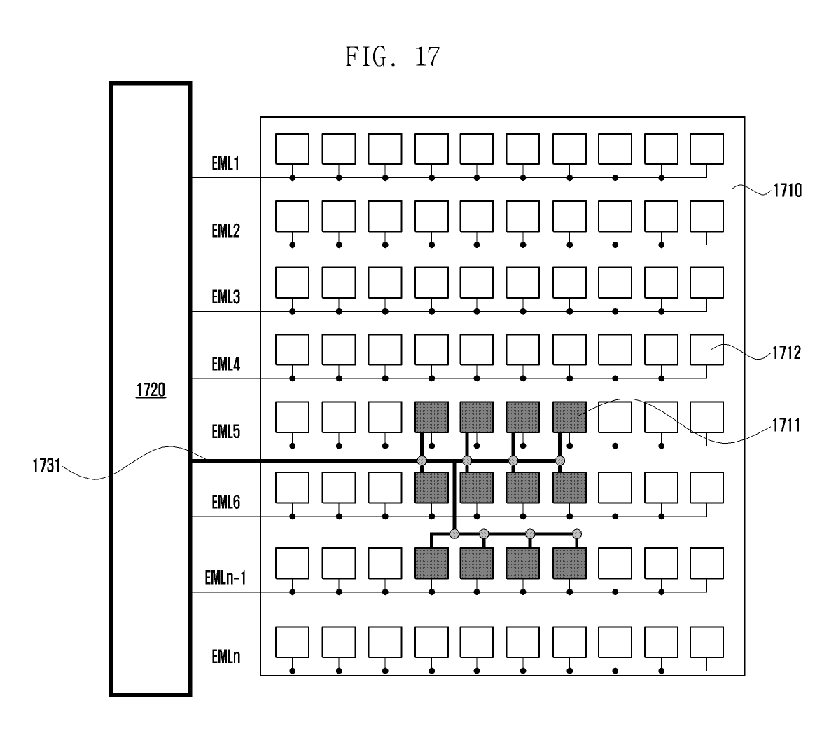

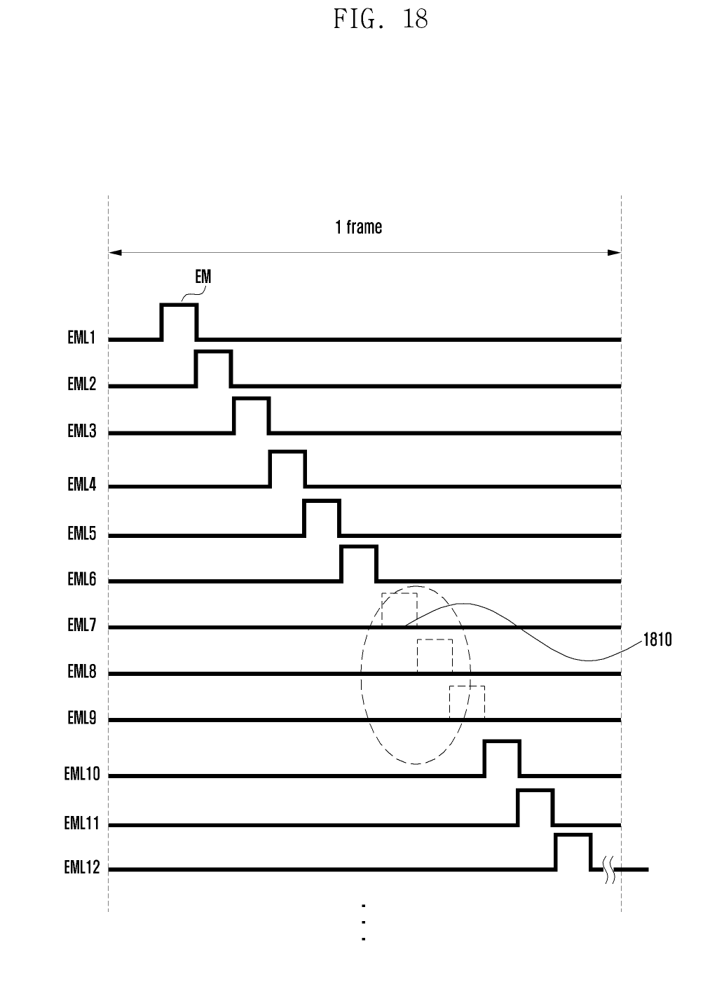

FIG. 17 is a block diagram illustrating a line for supplying a light emitting signal to each pixel of the display according to an embodiment of the present disclosure. FIG. 18 is a diagram illustrating a light emitting signal applied to a light emitting signal supply line according to an embodiment of the present disclosure.

Referring to FIG. 17, the display according to this exemplary embodiment may include a plurality of pixels arranged in a matrix. The plurality of pixels may include a plurality of first pixels 1711 positioned in the first area A1 and a plurality of second pixels 1712 positioned in the second area A2. The display 1310 may include a plurality of horizontal light emitting signal supply lines EML1 to EMLn connected to the plurality of pixels. The light emitting signal supply lines EML1 to EMLn may be the gate lines GL1 to GLn illustrated in FIG. 13. The A gate driver 1720 (e.g., the gate driver 1320) may supply the light emitting signal EM to the plurality of pixels through the light emitting signal supply lines EML1 to EMLn. According to one embodiment, the gate driver 1720 may sequentially supply the light emitting signal EM as illustrated in FIG. 18. For example, the gate driver 1720 may sequentially apply the light emitting signal EM from the first light emitting signal supply line EML1 to the last light emitting signal supply line EMLn. The time needed for this sequence may be known as a frame period. The light emitting signal EM may be a signal that is supplied to each pixel to turn on its driving thin film transistor. For example, the light emitting signal supply lines EML1 to EMLn may be connected to gate terminals of the driving thin film transistors TR5 and TR6 in the pixel driving circuit shown in FIG. 10.

The display may include a dummy line 1731 that is separately connected to the plurality of first pixels 1711 positioned in the first area Al. The dummy line 1731 may be connected to the gate terminals of the driving thin film transistors of the plurality of first pixels 1711 separately from the light emitting signal supply lines EML1 to EMLn. The gate driver 1720 may apply the gate-off voltage to the dummy line 1731 when the electronic device is in the sensing state. Accordingly, although the light emitting signal EM is sequentially applied to the light emitting signal supply lines EML1 to EMLn, the plurality of first pixels 1711 may still be turned off by the dummy line 1731. As illustrated by reference numeral 1810 in FIG. 18, some of the light emitting signals EM supplied to the first area A1 does not turn on the driving thin film transistor provided in the pixels in the first area A1.

Therefore, the display 1710 may selectively turn off only the driving thin film transistors provided in the first area Al when the electronic device is in the sensing state. Accordingly, when the electronic device drives the optical fingerprint sensor in the sensing state, the driving thin film transistors provided in the first area Al are turned off, and unintended leakage current and light leakage may be prevented.

According to another embodiment of the present disclosure, the display may include only the light emitting signal supply lines EML1 to EMLn without the separate dummy line 1731. In this case, when the electronic device is in the sensing state, the gate driver 1720 sequentially supplies the light emitting signal EM to the light emitting signal supply lines EML1 to EMLn but may not supply the light emitting signal EM to the light emitting signal supply line connected to the first area A1. For example, as illustrated in FIG. 18, when the light emitting signal supply line connected to the first area A1 is EML7 to EML9, the gate driver 1720 may not supply the light emitting signal EM to the EML7 to EML9 when the electronic device is in the sensing state. Then, the driving thin film transistors of the pixels in the first area A1 may be turned off

Thus, according to embodiments of the present disclosure, when hover or touch input is detected in the first area A1, the electronic device may turn off only the pixels in the first area A1.

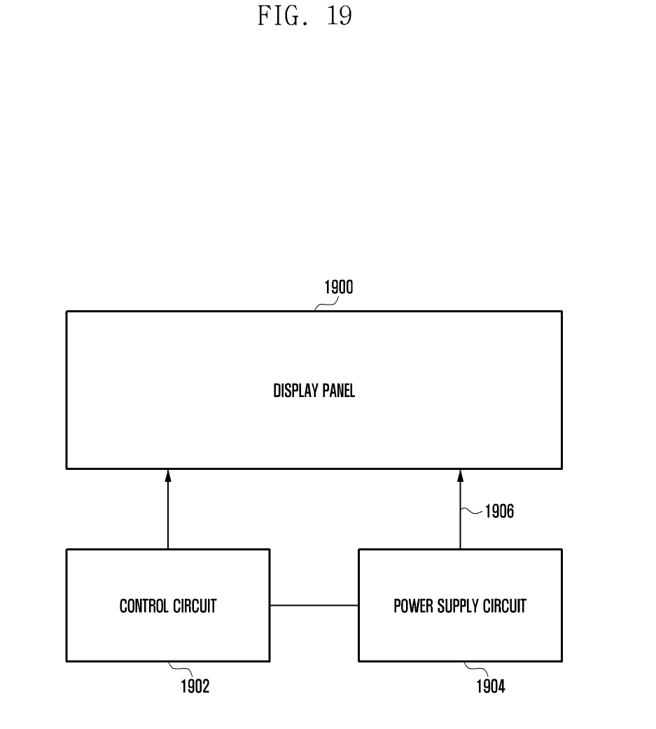

FIG. 19 is a block diagram illustrating a control circuit and a power supply circuit of a display according to an embodiment of the present disclosure.

Referring to FIG. 19, the controller 1902 may supply power to a display panel 1900 through an external power supply circuit 1904 and supply an image signal to the display panel 1900. According to one embodiment, when the display panel 1900 is an LCD panel that displays images using a backlight unit as a light source, the power supply circuit 1904 may be an LED driver IC and may supply power to the backlight unit. According to another embodiment, if the display panel 1900 is an OLED display, the power supply circuit 1904 may be a DC/DC (direct-direct) IC and may supply ELVDD and ELVSS 1906 to the display panel 1900.

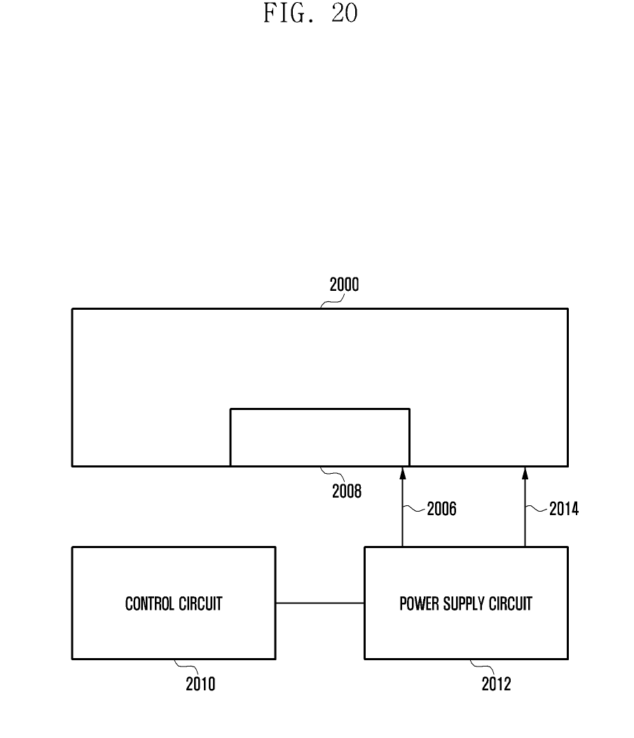

FIG. 20 is a block diagram illustrating an example in which a light emitting power supply of a panel area corresponding to a fingerprint sensor is separated from a display panel, according to an embodiment of the present disclosure.

As explained above, when the optical fingerprint sensor uses a separate light source (e.g., an IR LED) that is not the light emitted from a display panel 2000, leakage current may occur in the transistors controlling the pixels that overlap with the optical fingerprint sensor. Therefore, when the fingerprint sensor is operational, the pixels in the display area corresponding to the fingerprint sensor may be turned off. According to one embodiment, a power supply wiring 2006 connected to the display area 2008 in which the fingerprint sensor is positioned is provided separately from a power supply wiring 2014 to the rest of the display panel 2000. Accordingly, the control circuit 2010 may adjust the ELVSS voltage to the display area 2008 independently of the ELVSS voltage supplied to the rest of the display panel 2000. The control circuit 2010 may control the power supply circuit 2012 to turn off the power for the display area 2008. The control circuit 2010 (e.g., DDI 741) may include an algorithm that minimizes the effect by the light source of the fingerprint sensor on the image quality displayed in the display area 2008, but doing so in a way that does not change the performance of the fingerprint sensor.

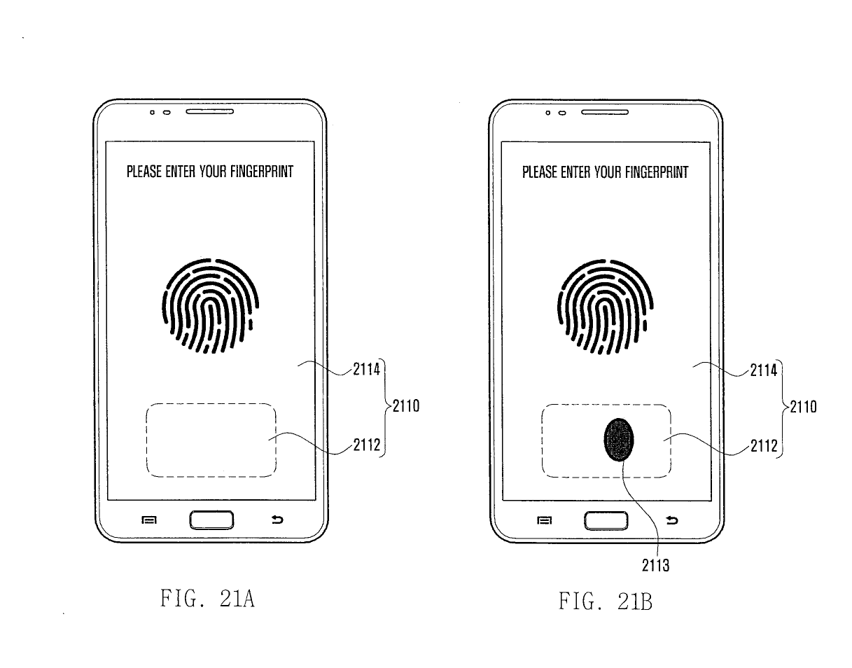

FIGS. 21 A and 21 B are diagrams illustrating a method of controlling a display while the electronic device according to another embodiment of the present disclosure senses fingerprint information.

The sensing state of the electronic device may include a first state as illustrated in FIG. 21 A and a second state as illustrated in FIG. 21 B

The electronic device (e.g., electronic device 101) may request biometric information authentication from the user and sense a touch or hovering input to at least a part of a display 2110 from the user. For example, the electronic device may display a message requesting a user to enter his or her fingerprint by controlling the second area 2114 of the display 2110 (e.g., display 160) to display a corresponding message in the first state. The electronic device may sense the touch or hovering input from the user using the touch sensor disposed in the first area 2112 of the display 2110 in the first state.

In the second state, when the touch or hovering input is sensed from the user, the electronic device activates the biometric sensor to recognize the user's biometric information. For example, if the electronic device senses the touch or hovering input to the first area 2112 from the user in the second state, the electronic device separately controls the first area 2112 of the display 2110 and activates the biometric sensor disposed in the first area 2112 to sense the fingerprint information of the user. As explained above, to avoid interference with the biometric sensor and the display, pixels in the first area 2112 may be turned off.

The example illustrated in FIGS. 11A and B are different from the example illustrated in FIGS. 21A and B in that the example of FIGS. 11A and B turns off the whole of the area 1112 when the electronic device is in the sensing state, whereas the example of FIGS. 21A and B turns off only the partial area 2113 within the first area 2112. The partial area 2113 may correspond to the location of the touch or hover input. Thus, the electronic device as illustrated in FIGS. 21A and B may minimize the effects on image quality displayed in the display 2110 caused by the biometric sensing operation.

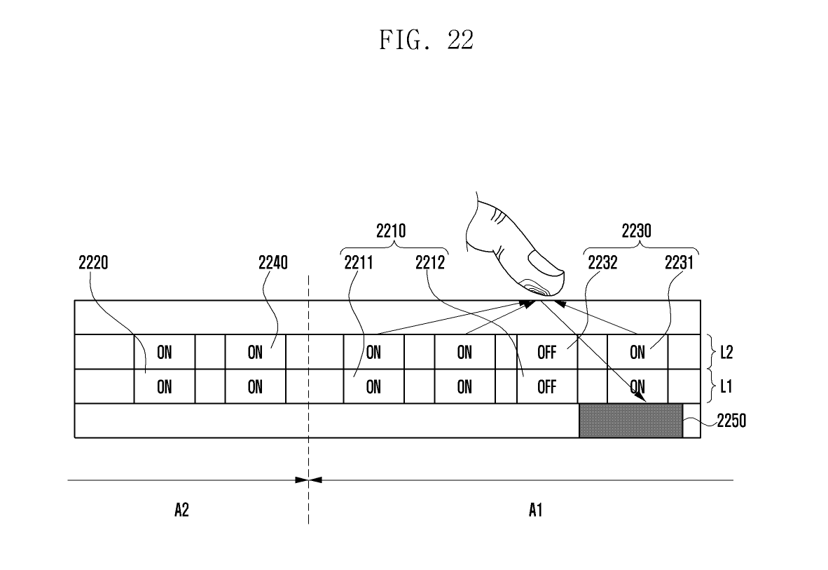

FIG. 22 is a diagram schematically illustrating a cross section of a display in a sensing state of an electronic device, according to an embodiment of the present disclosure.

Referring to FIG. 22, the display includes a first layer L1 on which at least one thin film transistor 2210 and 2220 are formed, a second layer L2 positioned above the first layer L1 where organic light emitting diodes OLED 2230 and 2240 are formed. The fingerprint sensor may include a light emitting device including organic light emitting elements 2231 and 2232 that emit light having a specific wavelength in the second layer L2 and a light receiving element 2250 positioned under the first layer L1. The light emitting elements 2231 and 2232 may emit the light having the specific wavelength in the sensing state of the electronic device. If the light emitted from the light emitting elements 2231 and 2232 is reflected from the user's fingerprint, the light receiving element 2250 may recognize the fingerprint by sensing the reflected light.

When touch or hovering input to the first area A1 from the user is detected in the sensing state, the electronic device may turn off the pixels in the first area A1 and turn on the pixels in the second area A2. For example, the electronic device may turn off only thin film transistors 2211 and 2212 in the first area A1 and turn on the organic light emitting diode (OLED) 2240 in the second area A2. In addition, the electronic device may activate the operation of the light emitting element 2230 and the light receiving element 2250 disposed in the first area Al to sense the fingerprint information of the user.

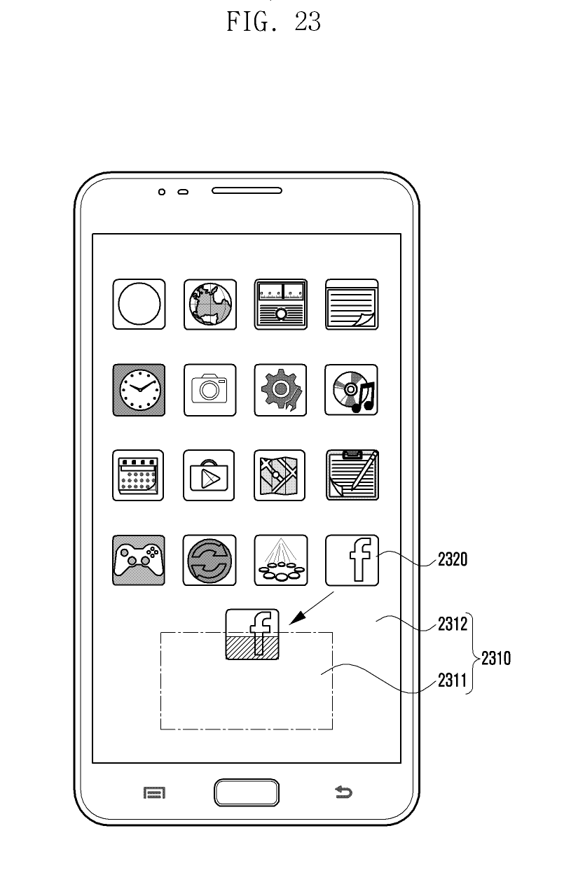

FIG. 23 is a diagram illustrating a sensing state of an electronic device according to an embodiment of the present disclosure.

Referring to FIG. 23, the electronic device does not turn off the whole of the first area 2311 of the display 2310 in the sensing state, and turn off only the portion where the drag input is sensed. For example, the electronic device may provide a plurality of icons 2320 corresponding to a plurality of applications. When the user selects the specific icon 2320 positioned in the second area 2312 and drags the selected icon 2320 to the first area 2311, only the portion of the specific icon 2320 entering the first area 2311 among is turned off. For example, this portion may be displayed as an area in black.

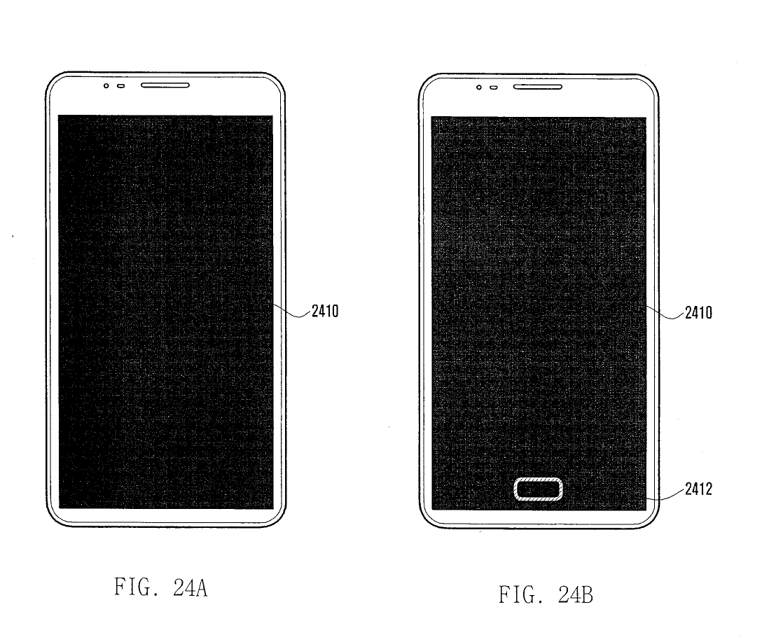

FIGS. 24 A and 24 B are diagrams illustrating a case in which an electronic device according to an embodiment of the present disclosure is in a sleep state.

FIG. 24 A illustrates a first state of the electronic device when it is in the sleep state and FIG. 24 B illustrates a second state of the electronic device in the sleep state.

Referring to FIG. 24A, in the first state, the electronic device may activate the touch sensor of the first area 2412, and deactivate the operation of the remaining components. The electronic device may switch to the second state when touch or hovering input is sensed in the first area 2412 by the touch sensor. In the second state, the electronic device may activate the operation of the fingerprint sensor, also located in the first area 2412, to sense the fingerprint information of the user. During the second state, the electronic device may partially turn on the first area 2412 to indicate to the user the location of the first area 2412, thereby showing the user where his or her finger should be placed. When this happens, light leakage may occur because both the pixels and the fingerprint sensor in the first area 2412 are on. However, this light leakage may serve to indicate the position of the first area 2412 to the user. According to another embodiment, in the second state, the electronic device drives the first area 2412 of the display 2410 to display a specific color, thereby indicating the position of the first area 2412 to the user.

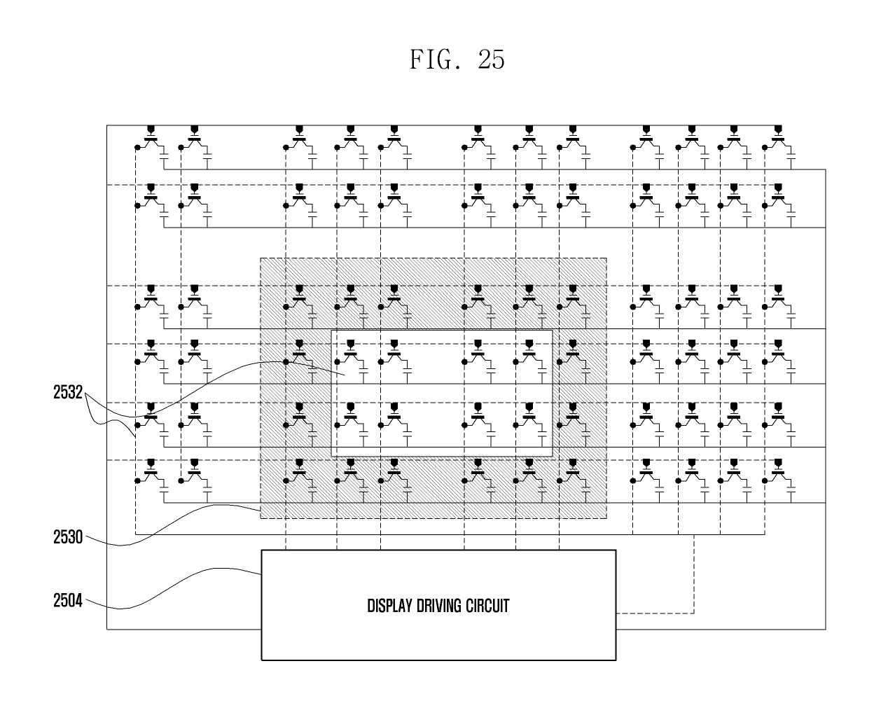

FIG. 25 is a circuit diagram illustrating a method for partially controlling a transistor of a display panel according to an embodiment of the present disclosure.

Referring to FIG. 25, the electronic device according to this embodiment of the present disclosure may sense the input of the user (e.g., hover input) and selectively/partially turn on/off transistors disposed on the display panel based on the state information (e.g., sleep state) of the electronic device to inform the user of the position where the fingerprint sensing is performed. For example, a display driving circuit 2504 of the electronic device may control the area 2530 of the display panel to be on and the other area 2532 to be off. Accordingly, the plurality of transistors disposed in the area 2530 are activated to emit light, and the electronic device may recognize the user's fingerprint using the emitted light.

A method for controlling an electronic device according to one embodiment of the present disclosure, in which a biometric sensor is disposed in at least a part of a display area of a display and the display area includes a first area corresponding to a location of the biometric sensor and a second area separate from the first area, may include if a touch or hover input from a user to the first area is sensed, differently controlling driving states of the first area and the second area; and acquiring biometric information of the user using the biometric sensor. The operation of controlling the driving state of the first area may further include turning off one or more pixels in the first area. The one or more pixels are organic light emitting diodes, and the operation of turning off the one or more pixels in the first area may further include controlling an

ELVSS voltage supplied to the one or more pixels in the first area so that the ELVSS voltage has no potential difference from an ELVDD voltage. The one or more pixels may further include thin film transistors for turning the one or more pixels on or off in response to a light emitting signal, and the operation of turning off the one or more pixels in the first area may further include controlling the light emitting signal to turn off the thin film transistors. The thin film transistors in the first area may be connected to a dummy line, and the operation of turning off the one or more pixels in the first area may further include turning off the thin film transistors in the first area via a signal transmitted through the dummy line. While the one or more pixels in the first area are turned off, one or more pixels in the second area remain on. The method may further include: controlling the first area to display a preset specific color at maximum luminance if the touch or hover input from the user to the first area is sensed, and acquiring the biometric information of the user using a light receiving element of the biometric sensor disposed under the display or embedded in the display. The preset specific color may include red or green. The method may further include: determining whether the electronic device is in a sleep state; sensing the touch or hover input from the user to the first area when the electronic device is in the sleep state; and if the touch or hover input from the user to the first area is sensed, controlling the one or more pixels in the first area to indicate to the user a location of the first area. The operation of turning off the one or more pixels in the first area may further include not applying the light emitting signal to the thin film transistors in the first area.

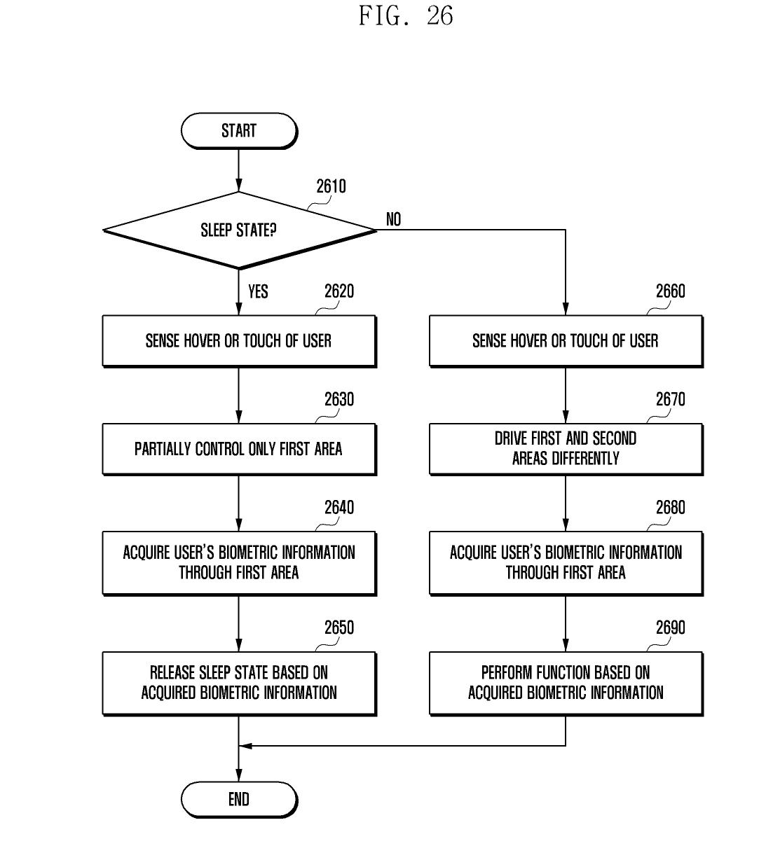

FIG. 26 is a flow chart illustrating an operation of the electronic device according to an embodiment of the present disclosure.

In operation 2610, it may be determined whether the electronic device is in the sleep state.

In operation 2620, if the electronic device is in the sleep state, it may sense the hovering or touch input of the user to the first area.

In operation 2630, the electronic device may activate the display and the fingerprint sensor in the first area if touch or hovering input is sensed. For example, the electronic device may partially drive only the first area of the display to control the first area to display a specific color, in order to indicate the position of the first area to the user.

In operation 2640, the electronic device may obtain the biometric information of the user through the biometric sensor positioned in the first area. For example, the electronic device may activate the fingerprint sensor positioned in the first area to sense the fingerprint information of the user.

In operation 2650, the electronic device may release the sleep state based on the acquired biometric information of the user.

In operation 2660, it may be determined whether the electronic device is not in the sleep state. In the wake state, the electronic device may sense the hovering or touch input of the user to the first area and switch to the sensing state. For example, the electronic device may switch to the sensing state after sensing hovering or touch input when a specific application requiring user authentication, such as mobile banking, is displayed on the display.

In operation 2670, the electronic device may drive the first area and the second area of the display differently. For example, the electronic device may turn off the display of the first area while maintaining the on state of the second area. In addition, the electronic device may activate the biometric sensor, for example, the fingerprint sensor, positioned in the first area. According to one embodiment, the electronic device may vary the ELVSS voltage supplied to the first area to turn off the display of the first area. According to another embodiment, in order to turn off the display of the first area, the electronic device may use a dummy line connected to the first area and applies the gate-off voltage through the connected dummy line to turn off the driving thin film transistors included in the first area.

In operation 2680, the electronic device may obtain the biometric information of the user through the biometric sensor positioned in the first area. For example, the electronic device may activate the fingerprint sensor positioned in the first area to sense the fingerprint information of the user.

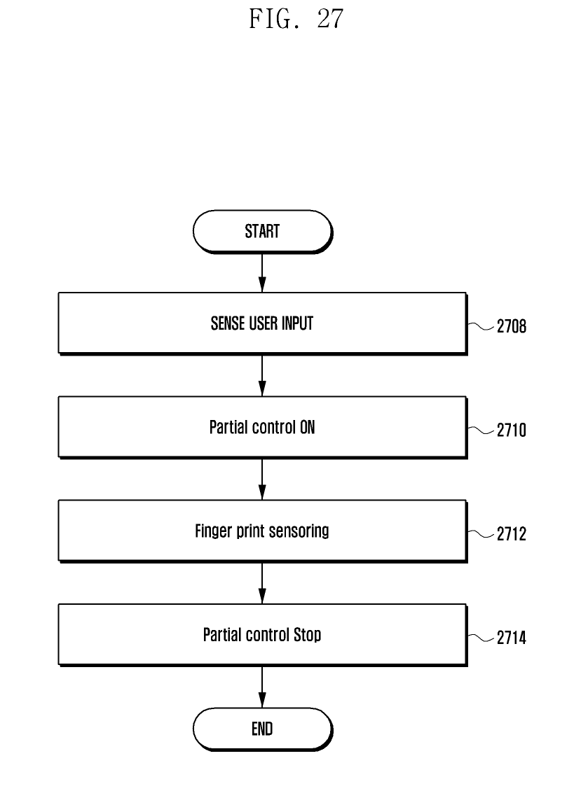

In operation 2690, the electronic device may perform the function based on the acquired biometric information of the user. FIG. 27 is a flow chart illustrating a process of partially controlling a display according to an embodiment of the present disclosure.

In operation 2708, the electronic device may sense the input of the user, such as touch or hovering input.

In operation 2710, the electronic device may start the partial control of the display if the input of the user is sensed. According to one embodiment, the electronic device may control some area of the display. For example, the electronic device may control the brightness, the luminance, or the R/G/B values for some area of the display corresponding to the input of the user, or variably control the transistor, the power supply, etc. of the some area of the display. According to one embodiment of the disclosure, the electronic device may track the movement of the input of the user and perform the partial control on the area corresponding to the movement.

In operation 2712, the electronic device may obtain a user's fingerprint through a fingerprint sensor within the electronic device. According to various embodiments, the fingerprint sensor may be formed within the display or disposed to overlap at least some area of the display.

In operation 2714, the electronic device may stop the partial control operation if the acquisition of the user's fingerprint is complete.

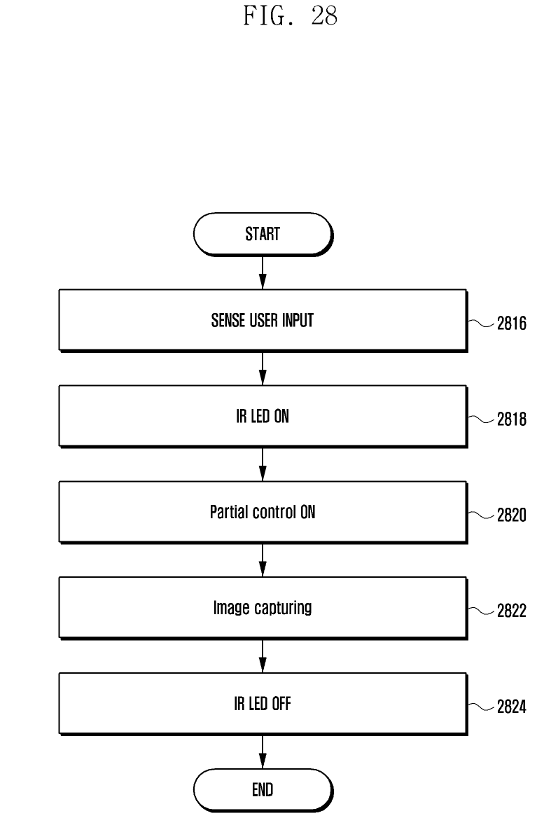

FIG. 28 is a flow chart illustrating a process of partially controlling a display that includes the driving of an IR LED, according to an embodiment of the disclosure.

In operation 2816, the electronic device may sense the input of the user (e.g. touch or hover input) and may activate a light source for acquiring the biometric information (e.g., fingerprint information). According to an embodiment of the present disclosure, the light source may be an infrared light emitting diode (IR LED), a laser, or the like.

In operation 2818, the electronic device may activate the IR LED.

In operation 2820, the electronic device may start the partial control of the display. For example, the electronic device may control some area of the display. For example, the electronic device may variably control the transistor, the power supply, or the like of the display corresponding to the input of the user. According to one embodiment of the disclosure, the electronic device may track the movement of the user input and perform the partial control on the area corresponding to the movement. The electronic device may perform the operation of turning on/off the power supply to the transistors in the area corresponding to the input of the user. For example, if the light source is an IR LED, the electronic device may stop the power supply supplied to the corresponding display pixel to prevent the undesired luminance of the pixel due to the infrared rays emitted by the IR LED.

According to one embodiment of the disclosure, the operations 2818 and 2820 may be performed in reversed order. For example, after sensing the user input, the electronic device may turn off the power supply of the area corresponding to the user input and then turn on the IR LED light source.

In operation 2822, the electronic device may obtain a user's fingerprint through a fingerprint sensor of the electronic device.

In operation 2824, the electronic device may stop the partial control operation if the acquisition of the fingerprint is complete.

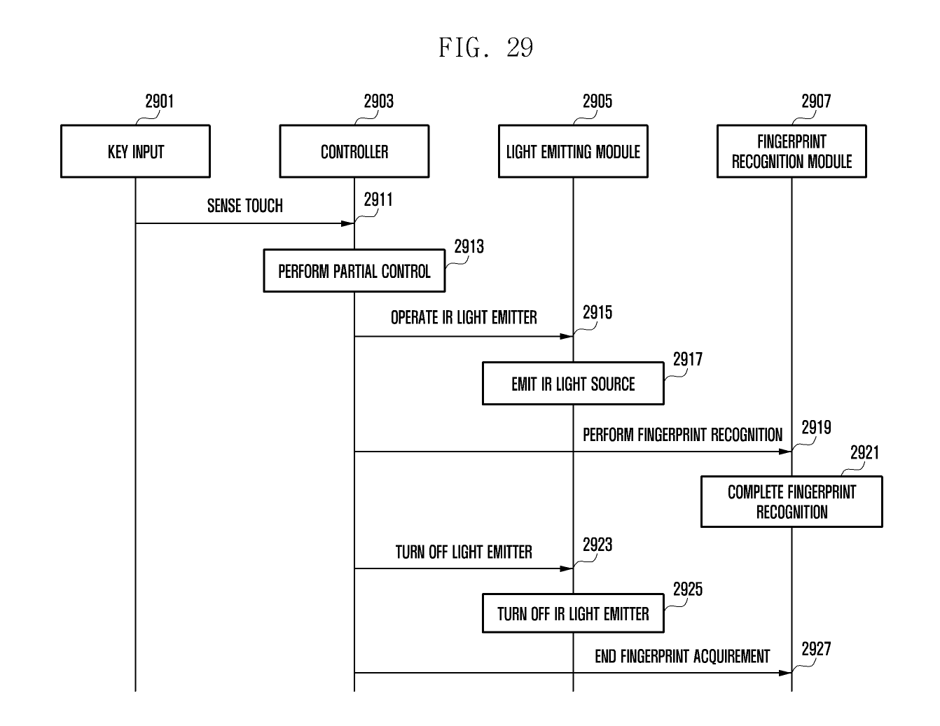

FIG. 29 is a flow chart of an operation of an electronic device according to an embodiment of the present disclosure.

In operation 2911, a key input 2901 of the electronic device senses an input of the user (e.g. touch or hover input). And if user input is sensed, the key input 2901 transmits a signal to the controller 2903.

In operation 2913, the controller 2903 of the electronic device may start the partial control of the display. For example, the electronic device may control some area of the display. For example, the electronic device may variably control the transistor, the power supply, or the like in the area of the display corresponding to the input of the user. According to one embodiment of the disclosure, the electronic device may track the movement of the user input and perform the partial control on the area corresponding to the movement. According to one embodiment, the electronic device may perform the operation of turning on/off the power supply to the transistors in the area corresponding to the input of the user.

In operation 2915 and operation 2917, the controller 2903 may control the light emitting module 2905 to emit light for the purposes of acquiring biometric information (e.g., fingerprint information). According to an embodiment of the present disclosure, the light source may be an IR LED. For example, the controller 2903 may activate the light emitting module 2905, and the light emitting module 2905 may output infrared light.

In operation 2919, the controller 2903 may perform fingerprint recognition by controlling a fingerprint recognition module 2907 when the IR LED is activated.

In operation 2921 and operation 2923, the controller 2903 deactivates the light emitting module 2905 if the acquisition of the user's fingerprint is completed through the fingerprint recognition module 2907.

In operation 2927, the controller 2903 may terminate the process of acquiring the user's fingerprint after the light emitting module 2905 is turned off.

According to various embodiments of the present disclosure, it is possible to have larger screen area (display area) of the display by allowing the biometric sensor to be arranged to overlap the display area. In doing so, various embodiments of the present disclosure may partially control the display in the sensing state of the electronic device to prevent leakage current that interferes with the display.

A programming module according to embodiments of the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

While the invention has been shown and described with reference to certain embodiments thereof, it will be understood by those skilled in the art that various changes in form and detail may be made therein without departing from the spirit and scope of the invention as defined by the appended claims.

What is claimed is:

1. An electronic device, comprising:
a display including a first area having a first pixel controlled by a first signal and powered by a first power supply and a second area having a second pixel controlled by a second signal and powered by a second power supply; and
a biometric sensor disposed in the first area and configured to acquire biometric information.

2. The electronic device of claim 1, wherein the first signal includes a signal for changing luminance, color, or brightness of the first pixel.

3. The electronic device of claim 1, wherein the first signal includes a signal for changing power supplied by the first power supply.

4. The electronic device of claim 1, wherein power supplied by the first power supply includes a first ELVSS voltage and a first ELVDD voltage that are supplied to the first pixel, and
power supplied by the second power supply includes a second ELVSS voltage and a second ELVDD voltage that are supplied to the second pixel.

5. The electronic device of claim 4, wherein the first ELVSS voltage has no potential difference from the first ELVDD voltage when the biometric sensor is activated.

6. The electronic device of claim 1, wherein the first signal includes an EM signal for turning on the first pixel.

7. The electronic device of claim 6, wherein the EM signal is not supplied to the first pixel when the biometric sensor is activated.

8. An electronic device, comprising:
a display configured to include a display area and a non-display area;
a biometric sensor disposed in at least a part of the display area of the display; and
a processor configured to control the display and the biometric sensor,
wherein the display area includes a first area corresponding to a location of the biometric sensor and a second area separate from the first area, and
wherein, if a touch or hover input from a user to the first area is sensed, the processor is further configured to:
differently control driving states of the first and second areas, and
acquire biometric information of the user using the biometric sensor.

9. The electronic device of claim 8, wherein the biometric sensor includes a light emitting element that is disposed under the display or embedded in the display and a light receiving element that is disposed under the display or embedded in the display, and to control the driving state of the first area, the processor is further configured to turn off one or more pixels in the first area.

10. The electronic device of claim 9, wherein the one or more pixels are organic light emitting diodes, and
to turn off the one or more pixels in the first area, the processor is further configured to control an ELVSS voltage supplied to the one or more pixels in the first area so that the ELVSS voltage has no potential difference from an ELVDD voltage.

11. A method for controlling an electronic device in which a biometric sensor is disposed in at least a part of a display area of a display and the display area includes a first area corresponding to a location of the biometric sensor and a second area separate from the first area, the method comprising:
if a touch or hover input from a user to the first area is sensed, differently controlling driving states of the first area and the second area; and
acquiring biometric information of the user using the biometric sensor.

12. The method of claim 11, wherein controlling the driving state of the first area further comprises turning off one or more pixels in the first area.

13. The method of claim 12, wherein the one or more pixels are organic light emitting diodes, and
turning off the one or more pixels in the first area further comprises controlling an ELVSS voltage supplied to the one or more pixels in the first area so that the ELVSS voltage has no potential difference from an ELVDD voltage.

14. The method of claim 12, wherein the one or more pixels further comprises thin film transistors for turning the one or more pixels on or off in response to a light emitting signal, and turning off the one or more pixels in the first area further comprises controlling the light emitting signal to turn off the thin film transistors, wherein the one or more pixels further comprises thin film transistors for turning the one or more pixels on or off in response to a light emitting signal, and
turning off the one or more pixels in the first area further comprises controlling the light emitting signal to turn off the thin film transistors.

15. The method of claim 14, wherein the thin film transistors in the first area are connected to a dummy line, and turning off the one or more pixels in the first area further comprises turning off the thin film transistors in the first area via a signal transmitted through the dummy line.

16. The method of claim 12, wherein while the one or more pixels in the first area are turned off, one or more pixels in the second area remain on.

17. The method of claim 11, further comprising:
controlling the first area to display a preset specific color at maximum luminance if the touch or hover input from the user to the first area is sensed; and
acquiring the biometric information of the user using a light receiving element of the biometric sensor disposed under the display or embedded in the display.

18. The method of claim 17, wherein the preset specific color includes red or green.

19. The method of claim 12, further comprising:
determining whether the electronic device is in a sleep state;
sensing the touch or hover input from the user to the first area when the electronic device is in the sleep state; and
if the touch or hover input from the user to the first area is sensed, controlling the one or more pixels in the first area to indicate to the user a location of the first area.

20. The method of claim 14, wherein turning off the one or more pixels in the first area further comprises not applying the light emitting signal to the thin film transistors in the first area.
